(19) United States
(12) Patent Application Publication
(10) Pub. No.: US 2026/0057171 A1
(43) Pub. Date: Feb. 26, 2026

(54) TERMINAL DEVICE, SERVER, AND SYSTEM

(71) Applicant: PRECISION CO., LTD., Tokyo (JP)

(72) Inventor: Hisahiko SATO, Tokyo (JP)

(73) Assignee: PRECISION CO., LTD., Tokyo (JP)

(21) Appl. No.: 19/357,616

(22) Filed: Oct. 14, 2025

Related U.S. Application Data
(63) Continuation of application No. PCT/JP2024/014740, filed on Apr. 11, 2024.

(30) Foreign Application Priority Data
Apr. 14, 2023 (JP) 2023-066733
Apr. 17, 2023 (JP) 2023-067226
Sep. 21, 2023 (JP) 2023-155573

(51) Int. Cl. G06F 40/186; G06F 3/04842

(52) U.S. Cl. CPC G06F 40/186; G06F 3/04842

(57) ABSTRACT

A terminal device includes a memory; and one or more processors operatively coupled to the memory and configured to maintain, in the memory, structured data of an electronic medical record (EMR) template, the structured data associating input items of the EMR template with input content, the input content including at least one of selectable input content and free text input content, accept, from a user, text data including an input item of the EMR template and input content corresponding to the input item, and identify, based on at least one of the selectable input content and the free text input content included in the text data, record content to populate the EMR template data.

### CROSS-REFERENCE TO RELATED APPLICATION

This application is a continuation of International Application No. PCT/JP2024/014740, filed Apr. 11, 2024, which claims priorities to Japanese Patent Application No. 2023-066733, filed Apr. 14, 2023, Japanese Patent Application No. 2023-067226, filed Apr. 17, 2023 and Japanese Patent Application No. 2023-155573, filed Sep. 21, 2023, the entire contents of each are incorporated herein by reference.

### FIELD

The present disclosure relates to a terminal device, a server, and a system.

### BACKGROUND

Electronic medical records (EMRs) that electronically record the contents and results of interviews (medical questioning) performed by a physician with respect to a patient, and that further electronically record a history of medical acts performed on the patient, are publicly known. The record content of an EMR is sometimes created in accordance with an electronic medical record (EMR) template.

As technology related to the above-described technique, there is a technique disclosed in Japanese Unexamined Patent Application Publication No. 2013-156844.

Japanese Unexamined Patent Application Publication No. 2013-156844 discloses technology relating to a medical support apparatus. In the medical support apparatus, an input item display means displays input items on a display. An input item selection means selects one input item from among a plurality of the input items. A speech-recognition means, using a selected dictionary, performs speech-recognition on input speech and extracts phrase candidates for the speech. A phrase candidate display means displays the extracted phrase candidates on the display. A selection operation reception means receives a selection operation of one phrase candidate from among the phrase candidates. A storage control means causes a storage means to store the one phrase candidate that has been selected as an answer for the selected input item. Prior Art Document.

In the technology described in Patent Literature 1, speech-recognition processing is performed using a specialized dictionary in the medical field; however, in template input operations in the medical field there are many homophones with different written forms, and even at present there are inherent limits to the accuracy of speech-recognition processing. Consequently, after speech-recognition processing has been performed, it may become necessary for a physician or the like to make a corrective input to the input content for the electronic medical record (EMR) template that is the result of the speech-recognition processing.

Accordingly, the present disclosure has been made in view of the above issue, and an object of the present disclosure is to provide technology that achieves labor saving in recording to an electronic medical record (EMR) template based on input text data.

### SUMMARY OF THE INVENTION

A program for operating a computer includes a processor and a memory.

Structured data of an electronic medical record (EMR) template is stored in the memory. The structured data is data in which input items of the EMR template are associated with input content, and the input content includes at least one of selectable input content, in which an option is selected, and free-text input content, in which free description is possible. The program causes the processor to execute: a first step of accepting, from a user, input of text data including input items of the EMR template and input content corresponding to the input items; and a second step of identifying, based on at least one of selectable input content and free-text input content included in the text data, record content to be recorded in EMR template data. Advantageous Effects of the Invention.

According to the present disclosure, it is possible to achieve labor saving in recording to an electronic medical record (EMR) template based on the input text data.

### BRIEF DESCRIPTION OF DRAWINGS

FIG. 1 is a diagram illustrating an overall configuration of a system according to one embodiment.

FIG. 2 is a diagram illustrating a functional configuration of a terminal apparatus according to one embodiment.

FIG. 3 is a diagram illustrating a functional configuration of a server according to one embodiment.

FIG. 4 is a diagram illustrating a data structure of an electronic medical record database according to one embodiment.

FIG. 5 is a flowchart illustrating an example of processing flow in the system according to one embodiment.

FIG. 6 is a flowchart illustrating another example of processing flow in the system according to one embodiment.

FIG. 7 is a flowchart illustrating yet another example of processing flow in the system according to one embodiment.

FIG. 8 is a schematic diagram illustrating an example of a screen displayed on a terminal apparatus according to one embodiment.

FIG. 9 is a schematic diagram illustrating another example of a screen displayed on a terminal apparatus according to one embodiment.

FIG. 10 is a schematic diagram illustrating yet another example of a screen displayed on a terminal apparatus according to one embodiment.

FIG. 11 is a schematic diagram illustrating still another example of a screen displayed on a terminal apparatus according to one embodiment.

FIG. 12 is a schematic diagram illustrating still another example of a screen displayed on a terminal apparatus according to one embodiment.

FIG. 13 is a schematic diagram illustrating still another example of a screen displayed on a terminal apparatus according to one embodiment.

FIG. 14 is a diagram for explaining a procedure for generating a referral letter by the system according to one embodiment.

FIG. 15 is a diagram for explaining a procedure for generating a referral letter by the system according to one embodiment.

### DETAILED DESCRIPTION

Embodiments of the present disclosure will be described below with reference to the drawings. In all of the drawings used to describe the embodiments, like reference numerals denote like constituent elements, and repetitive description will be omitted. The embodiments described below are not intended to unduly limit the scope of the present disclosure as set forth in the claims. Not all constituent elements shown in the embodiments are necessarily essential to the present disclosure. The drawings are schematic and are not necessarily strictly depicted.

In the following description, the term “processor” refers to one or more processors. At least one processor is typically a microprocessor such as a CPU (Central Processing Unit), but another type of processor such as a GPU (Graphics Processing Unit) may be used. The at least one processor may be single-core or multi-core.

In the present specification, at least one processor may also be implemented by a hardware logic circuit such as a field programmable gate array (FPGA) or an application specific integrated circuit (ASIC), in addition to implementation by a central processing unit (CPU) executing software on a general-purpose computer. A portion of the functions described as being performed by the processor may alternatively be executed by such dedicated hardware circuitry, and the wording “processor” is used herein to encompass those hardware implementations unless a context clearly requires distinction.

In the present specification, a term expressed in the form “X table” (for example, “patient table” or “input item table”) is sometimes used for convenience to denote structured information (a logical set of records) and is not limited to an actual table object of a relational database. Unless the context clearly dictates otherwise, such an “X table” may equivalently be referred to as “X information,” and the underlying data can be held in any data structure or storage format capable of providing substantially the same functional content.

In the present specification, data described as being stored in one table may, in implementation, be divided among two or more tables (or other data structures), or, conversely, data described as being stored separately can be merged into a single table (or data structure), provided that substantially the same logical association and retrievability of the data are maintained. Such splitting or merging does not depart from the scope of the disclosure.

In the present specification, for ease of explanation, a subject performing a processing operation can be expressed as a program, even though the operation is actually executed by one or more processors based on that program. Conversely, a description that a processor performs a certain operation may, where appropriate, be replaced with a description that a program causes a computer to execute the operation. Such substitutions in expression do not affect the technical substance.

A program according to the present disclosure can be provided to a user by being pre-installed in a computer (or an apparatus including such a computer), or by being stored on a computer-readable recording medium and distributed, or by being delivered via a communication network and then installed. The program can be provided in any of two or more (i.e., a plurality of) forms corresponding to differing operating systems or execution environments, and it is sufficient that a user obtain at least one form suitable for the user's environment.

In the present specification, an identifier used to distinguish elements, records, items, or the like is not limited to a numerical value. The identifier may instead be a character string, a code, a symbol, a graphic image, a color, a mark, or any combination thereof, provided that the identifier enables discrimination from other identifiers.

In the drawings, reference numerals are assigned primarily to assist understanding of the structure. Even if reference numerals are omitted in part of a drawing or a description, it does not mean that the portion is of lesser importance. Further, using different reference numerals for elements having substantially the same function does not necessarily indicate a substantial structural or functional difference, unless explicitly described.

In the drawings, illustrated control lines or information lines represent typical or functional connections. They do not necessarily indicate that such lines must always be physically realized exactly as shown. For example, a depicted control line may, in implementation, be replaced by a wireless link, a shared bus, a logical signal path implemented by software, or another equivalent communication mechanism.

### 0 System Overview

The system according to the present disclosure is a system that records electronic medical record (EMR) record content, based on an electronic medical record (EMR) template, by speech-recognition. In the present specification, EMR record content is generated based on the EMR template.

The electronic medical record (EMR) template is structured data having input items and input content associated with the respective input items. Herein, “structured data” refers to data that, prior to being placed in storage, is predefined and formatted into a prescribed structure. By contrast, “unstructured data” refers to data that is stored as plain text and is not processed until the time of use. An EMR has its input items defined based on the EMR template. The present system further encompasses a system that assists input of the input items of the EMR template by reconstructing the input items of the template in another form, such as a web form (an EMR template input assistance system).

An input item is an item corresponding to a respective item of an electronic medical record (EMR) and has a comparatively short content using a designated medical term so that a medical professional can identify which item it is. Input content is content that a physician or other medical professional inputs with respect to the input item with which that input content is associated. The form of the input content varies, and can be in a selectable answer form or a free-text field. If the input content is in a selectable answer form, one of the selectable options (even if there is only a single option) is selected; if the input content is in a free-text field, free text is input. Note that when the input content is in a selectable answer form, a designated medical term is included in the selection options. EMR template data are contents that a physician or medical professional has input based on the EMR template, and are the concrete contents of the input content of the EMR template.

In a medical setting, physicians and other medical professionals need to perform a large amount of data entry into an electronic medical record (EMR) based on an EMR template. The EMR template is structured data, some portions being in a selectable answer form and other portions being in a free-text field.

The input items and input content of an electronic medical record (EMR) template are created on the premise that medical professionals will input, revise, or append them, and that medical professionals will view them. Accordingly, the input items and input content presuppose medical knowledge and need to be medically accurate. However, the amount of record content that medical professionals including physicians must record in the EMR becomes enormous, and the burden is considerable. In one example, at an admission/discharge support center of a certain medical facility, there are input contents spanning roughly six pages, and locating where in an elongated vertical profile field or assessment sheet of the EMR to input those contents and then inputting them takes about twenty minutes per patient, which is a cause of overtime work for nurses and medical clerks.

From such a viewpoint, it is conceivable to perform recording of EMR record content by speech-recognition. However, even at the present time, the precision of speech-recognition processing cannot be said to be sufficient. Moreover, in order to raise the precision of speech-recognition, customization for each medical facility becomes necessary, but if the man-hours for such customization increase, the cost rises and hospital management is pressured. In the manufacturing field, a method called mass customization is used, in which manufacturing process design is performed on the premise of receiving customization of products, and the unit price of a product is raised; however, in the field of speech input of EMR templates, no precedent is known in which such a design has been adopted.

Accordingly, in the system according to the present disclosure, in performing recording of EMR record content based on an EMR template, designated medical terms included in speech data uttered by a medical professional are used as keys to identify input items and input content of the EMR template; which input item the speech data pertains to, and which input content item or selectable option the speech data pertains to, are identified; and, for the identified input item and input content, speech-recognition result data obtained by speech-recognition of the speech data are recorded, whereby the EMR record content is specified. By adopting such a configuration, it is possible to record EMR record content efficiently and accurately using speech-recognition technology.

To raise the precision of speech-recognition, the following three matters are important. A first matter is to collect past data that have been input into templates at each medical facility and, by performing machine learning of words included in the past data, create speech-recognition specialized for that template input, thereby raising precision. A second matter is to provide, at the time of speech input, a speech input guide user interface (UI) that induces the user to utter words that are already learned. Specifically, an example list of designated medical terms and, for input content, selectable options and example input are displayed on the inputter's screen, and by inducing the user, during speech input, to read as much as possible words displayed on the screen, precision is raised. A third matter is, using field data, to normalize homophones with different written forms to the same written form as much as possible, and, when necessary, to prompt more precise conversion to the appropriate kanji.

By sharing, among a plurality of medical facilities, an electronic medical record (EMR) template accompanied by a speech-recognition engine specialized for template input thus created and by a template input guide UI, it becomes possible to use high-precision speech-recognition throughout Japan.

As one type of electronic medical record (EMR) template, there exist a profile information sheet and an assessment sheet that a nurse inputs. Accordingly, the present invention also implies use for inputting data of items of a profile information sheet, an assessment sheet, or the like.

The precision of speech-recognition, like that of a human worker, does not become 100%. The ease with which correctness of input may be confirmed also has a large impact on user usability.

### Embodiment

### 1 Overall System Configuration Diagram

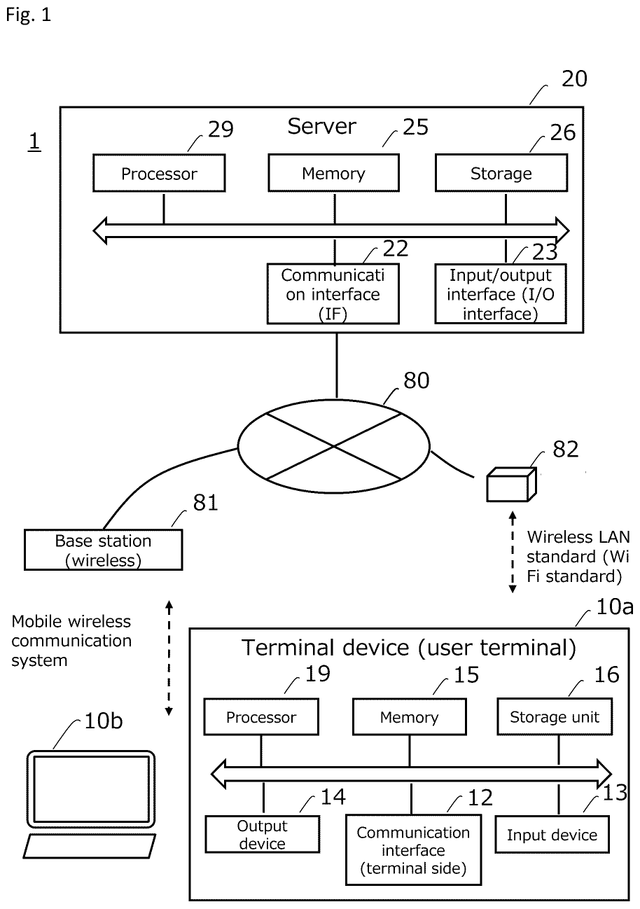

FIG. 1 is a diagram showing an overall configuration of an electronic medical record (EMR) system 1 according to this embodiment. As shown in FIG. 1, the EMR system 1 includes a plurality of terminal devices (in FIG. 1, terminal device 10a and terminal device 10b; hereinafter, these may be collectively referred to as “terminal device 10”) and a server 20. The terminal device 10 and the server 20 are connected so as to be mutually communicable via a network 80. The network 80 is configured by a wired or wireless network. In this embodiment, the server 20 is a server having a function as a Web server (including a cloud server), and performs exchange of information with the terminal device 10 by Web pages. A Web page browser for browsing Web pages is installed in the terminal device 10, but a dedicated application for providing services of the server 20 may be installed, and browsing may be enabled by the dedicated application.

The terminal device 10 is realized by a desktop personal computer (PC), a laptop PC, or the like. In addition, the terminal device 10 may be, for example, a tablet compatible with a mobile communication system, or a portable terminal such as a smartphone.

The terminal device 10 is a device operated by a medical professional or an administrator of the EMR system 1. Herein, a “medical professional” is a concept including a physician, a nurse, a laboratory technician having medical knowledge, and the like. In the following description, unless a distinction is made between a medical professional and an administrator of the system 1, the medical professional is deemed to include the administrator of the system 1.

A medical professional uses the terminal device 10 to perform recording of EMR record content based on an electronic medical record (EMR) template. At this time, the medical professional inputs speech data to the terminal device 10 and gives an instruction to input/modify/add. The terminal device 10 performs speech-recognition of the speech data to obtain speech-recognition result data, and performs input/modification/addition of record content based on the speech-recognition result data. The medical professional then gives an instruction to record, as EMR record content, the input content for which input/modification/addition has been performed.

Further, a medical professional can create/modify/add to an electronic medical record (EMR) template using the terminal device 10. At this time, the medical professional performs modification/addition/deletion of input items and input content of the EMR template (here, “deletion” includes not only completely deleting input content, and the like, but also consolidating a plurality of input contents into one input content to reduce the total number of input contents), and performs generation/modification/addition/deletion of selectable options of input content corresponding to input items.

The terminal device 10 is communicably connected to the server 20 via the network 80. The terminal device 10 connects to the network 80 by communicating with communication equipment such as a wireless base station 81 compatible with communication standards such as 4G, 5G, and LTE (Long Term Evolution), and a wireless LAN (Local Area Network) router 82 compatible with wireless LAN standards such as IEEE (Institute of Electrical and Electronics Engineers) 802.11. As shown in FIG. 1, the terminal device 10 includes a communication interface (IF) 12, an input device 13, an output device 14, a memory 15, a storage 16, and a processor 19.

The communication IF 12 is an interface for inputting and outputting signals so that the terminal device 10 can communicate with an external device. The input device 13 is an input device (for example, a keyboard, a touch panel, a touchpad, a mouse or other pointing device, and the like) for receiving an input operation from a user. The output device 14 is an output device (a display, a speaker, and the like) for presenting information to the user. The memory 15 temporarily stores programs and data processed by programs, and is, for example, a volatile memory such as dynamic random access memory (DRAM). The storage 16 is a storage device for storing data, and is, for example, a flash memory or a hard disk drive (HDD). The processor 19 is hardware for executing an instruction set described in a program, and is constituted by an arithmetic unit, registers, peripheral circuits, and the like.

The server 20 is administered by an EMR system administrator of the EMR system 1 of this embodiment, and its stored contents are appropriately modified/added/deleted by medical professionals who are users of the terminal device 10. The server 20 is an electronic medical record (EMR) device, and at a medical facility, a medical professional browses input items and input content of the EMR via the terminal device 10 and performs modification/addition of input content. Further, the server 20 accepts an editing operation of the EMR template performed by a medical professional via the terminal device 10, and modification/addition/deletion of the EMR template is performed based on the editing operation.

The server 20 is a computer connected to the network 80. The server 20 includes a communication interface (IF) 22, an input/output interface (input/output IF) 23, a memory 25, a storage 26, and a processor 29.

The communication IF 22 is an interface for inputting and outputting signals so that the server 20 can communicate with an external device. The input/output IF 23 functions as an interface with an input device for receiving an input operation from a user and an output device for presenting information to the user. The memory 25 temporarily stores programs and data processed by programs, and is, for example, a volatile memory such as dynamic random access memory (DRAM). The storage 26 is a storage device for storing data, and is, for example, a flash memory or a hard disk drive (HDD). The processor 29 is hardware for executing an instruction set described in a program, and is constituted by an arithmetic unit, registers, peripheral circuits, and the like.

### <1.1 Functional Configuration of Terminal Device 10>

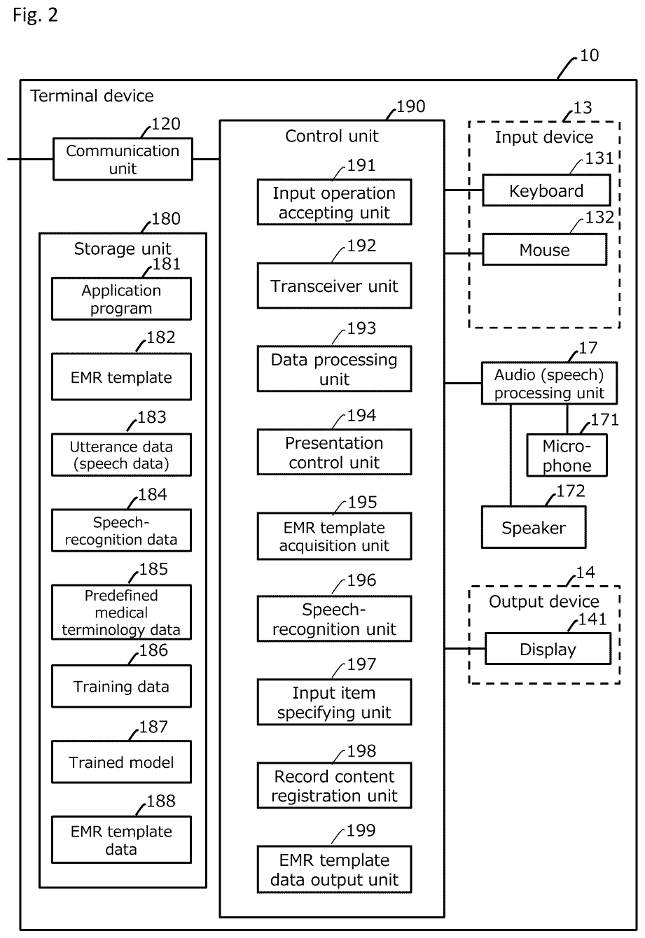

FIG. 2 is a block diagram illustrating an example of a functional configuration of the terminal device 10 shown in FIG. 1. The terminal device 10 shown in FIG. 2 is realized, for example, by a PC, a portable terminal, or a wearable terminal. As shown in FIG. 2, the terminal device 10 includes a communication unit 120, an input device 13, an output device 14, an audio processing unit 17, a microphone 171, a speaker 172, a storage section 180, and a control unit 190. Each block included in the terminal device 10 is electrically connected, for example, by a bus or the like.

The communication unit 120 performs processing such as modulation/demodulation processing for the terminal device 10 to communicate with another device. The communication unit 120 applies transmission processing to a signal generated by the control unit 190 and transmits it to the outside (for example, the server 20). The communication unit 120 applies reception processing to a signal received from the outside and outputs the processed signal to the control unit 190.

The input device 13 is a device by which a user operating the terminal device 10 inputs an instruction or information. The input device 13 can be realized, for example, by a keyboard, a mouse, or a reader. When the terminal device 10 is a portable terminal or the like, it is realized by a touch-sensitive device 131 by which an instruction is input by touching an operation surface. The input device 13 converts an instruction input by a user into an electrical signal and outputs the electrical signal to the control unit 190. The input device 13 may include, for example, a reception port for receiving an electrical signal input from an external input device.

The output device 14 is a device for presenting information to a user operating the terminal device 10. The output device 14 is realized, for example, by a display 141 or the like. The display 141 displays data in accordance with control by the control unit 190. The display 141 is realized, for example, by a liquid crystal display (LCD) or an organic electro-luminescence (EL) display.

The audio processing unit 17 performs, for example, digital-to-analog conversion processing of audio signals. The audio processing unit 17 converts a signal supplied from the microphone 171 into a digital signal and supplies the converted signal to the control unit 190. The audio processing unit 17 also supplies an audio signal to the speaker 172. The audio processing unit 17 is realized, for example, by a processor for audio processing. The microphone 171 receives speech input and supplies an audio signal corresponding to the speech input to the audio processing unit 17. The speaker 172 converts an audio signal supplied from the audio processing unit 17 into sound and outputs the sound to outside the terminal device 10.

The storage section 180 is realized, for example, by the memory 15 and the storage 16, and stores data and programs used by the terminal device 10. The storage section 180 stores, for example, an EMR template 182, speech data 183, speech-recognition result data 184, designated medical term data 185, teacher data 186, a learned model 187, and EMR template data 188.

The EMR template 182 is a template by which a medical professional performs recording of EMR record content using the EMR template 182, and is an EMR template 2024 that an EMR template acquisition unit 195 (described later) has acquired from a storage section 202 of the server 20. The EMR template 182 can be a part of the EMR template 2024. That is, as will be described in detail later, the EMR template 2024 stored in the storage section 202 of the server 20 is all of the EMR templates managed by the server 20 (that is, the EMR device), but the EMR template for which modification/addition is performed on the terminal device 10 as described later may be an EMR template used when a medical professional records record content at a particular medical facility and, at times, in a particular department of the particular medical facility.

The speech data 183 are data in which speech uttered by a medical professional has been captured via the microphone 171 of the audio processing unit 17.

The speech-recognition result data 184 are speech-recognition result data obtained as a result of performing speech-recognition, by a speech-recognition unit 196 of the control unit 190, based on the speech data 183. The speech-recognition result data 184 are, as one example, data in which kanji and hiragana are mixed, and may also be data of pairs of kanji and hiragana or katakana readings thereof.

The designated medical term data 185 are designated medical term data used by an input item identification unit 197 of the control unit 190, when performing modification/addition of input content of the electronic medical record (EMR) based on the speech-recognition result data 184, to identify an input item relating to input content for which modification/addition is to be performed. The designated medical terms referred to herein are terms used, not limited to EMRs, but generally by medical professionals when describing records, and at least include so-called medical terms, and further include specialized terms used in input items. Preferably, the designated medical term data 185 have a synonym dictionary of such designated medical terms and the like, and are used to identify and maintain linkage of items at the time of modification/update. Medical terms include, for example, “past medical history,” “present illness history (HPI),” “medication history,” “social history,” “disease name,” and “drug name,” which are used in medical facilities to accurately describe words relating to medicine. Also, there exist synonyms of “present illness history (HPI),” such as “present condition” and “HPI,” and at the time of linking templates, linkage may be induced or fixed using synonyms.

The learned model 187 is a learned model used when the speech-recognition unit 196 performs speech-recognition based on speech data 183 uttered by a medical professional and acquired by the microphone 171, and generates speech-recognition result data 184. That is, the learned model 187 takes the speech data 183 as input data and outputs the speech-recognition result data 184.

The learned model 187 is obtained by causing a machine learning model to perform machine learning, according to a model learning program (not shown), based on teacher data 186. The teacher data 186 are those generally used when performing speech-recognition by machine learning, and are composed of pairs of speech data of numerous speakers and text data correctly obtained by speech-recognition corresponding to the speech data. In this case, the terminal device 10 may have a plurality of learned models 187 and teacher data 186. Particularly in this embodiment, since a plurality of types of EMR templates 182 may be used, it is preferable to appropriately select the learned model 187 (and hence the teacher data 186 on which it is premised) depending on the EMR template; therefore it is preferable that the storage section 180 have a plurality of learned models 187 and teacher data 186 corresponding to the learned models 187.

In this embodiment, the learned model 187 is, for example, a parameterized composite function in which a plurality of functions are composed. The parameterized composite function is defined by a combination of a plurality of adjustable functions and parameters. The predictive model according to this embodiment can be any parameterized composite function satisfying the above requirements, but is taken to be a multilayer network model (hereinafter referred to as a multilayered network). A predictive model using a multilayered network has an input layer, an output layer, and at least one intermediate layer or hidden layer provided between the input layer and the output layer. The predictive model is assumed to be used as a program module that is part of artificial intelligence software.

As the multilayered network according to this embodiment, for example, a deep neural network (DNN), which is a multilayer neural network subject to deep learning, can be used. As the DNN, for example, a convolutional neural network (CNN), which targets images, may be used.

The above is merely an illustration of the predictive model, and the predictive model may have another configuration. For example, the predictive model can be a rule-based model described by a function in which coefficients derived from past performance are attached to each variable, using chief complaint information and environmental information as variables.

Preferably, the teacher data 186 include the speech data 183 accumulated in the past and the EMR templates 2024. That is, not only generic teacher data for speech-recognition, but also actual data suitable for speech-recognition for the EMR template 182 already incorporated as an EMR template, are preferred.

Preferably, the teacher data 186 include the designated medical term data 185. That is, the learned model 187 is a model learned by the designated medical term data 185. This makes it possible to improve speech-recognition precision by the speech-recognition unit 196 based on the speech data 183 including designated medical terms from a medical professional.

In addition, the teacher data 186 may include past accumulated EMR template data 2023; however, the past accumulated EMR template data 2023 naturally include personal information such as a patient name, date of birth, contact information, and very rare diseases. A personal information protection act strictly defines management methods for such personal information. Accordingly, using such restricted EMR template data 2023 for speech-recognition processing requires strict handling and entails a risk of personal information leakage. Therefore, in the system 1 according to the present disclosure, at least part of the actual EMR template data 2023 is anonymized or modified, thereby protecting personal information while also increasing the convenience of data utilization.

Specifically, as the teacher data 186, modification of the actual EMR template data 2023 is performed by, for example, increasing or decreasing part of numbers by a prescribed value, and replacing input content at the same input item with that of EMR template data 2023 of another patient. In addition, by masking proper nouns, personal information is anonymized. At the same time, morphological analysis is performed, and very rare words are masked in display.

It is also preferable that the teacher data 186 include data regarding relationships between kanji characters and their phonetic readings (kana). By using the learned model 187 that has performed machine learning with such teacher data 186, when, during identification of a correction by the input item identification unit 197 described later, a phonetic reading is input as speech data 183, it becomes possible to issue an instruction to substitute the phonetic reading with a kanji character having another similar sound.

The electronic medical record (EMR) template data 188 is data in which concrete input has been made for the input content of the EMR template 182 as a result of speech-recognition processing by the terminal device 10.

A control unit 190 is realized by the processor 19 reading the application program 181 stored in the storage unit 180 and executing instructions contained in the application program 181. The control unit 190 controls operations of the terminal device 10. By operating in accordance with the application program 181 stored in the storage unit 180, the control unit 190 functions as an operation acceptance unit 191, a transmit/receive unit 192, a data processing unit 193, a presentation control unit 194, an EMR template acquisition unit 195, a speech-recognition unit 196, an input item identification unit 197, a record content recording unit 198, and an EMR template data transmission unit 199.

An operation acceptance unit 191 performs processing for accepting instructions or information input from the input device 13. Specifically, for example, the operation acceptance unit 191 accepts information based on instructions input from a keyboard, a mouse, or the like.

The operation acceptance unit 191 also accepts voice instructions input from the microphone 171. Specifically, for example, the operation acceptance unit 191 receives a voice signal that is input from the microphone 171 and converted into a digital signal by the audio processing unit 17. For example, the operation acceptance unit 191 analyzes the received voice signal to extract a predetermined noun, thereby obtaining an instruction from a user.

A transmit/receive unit 192 performs processing for the terminal device 10 to transmit and receive data to and from an external device such as the server 20 in accordance with a communication protocol. Specifically, for example, the transmit/receive unit 192 transmits business content input by a user to the server 20. Further, the transmit/receive unit 192 receives information relating to the user from the server 20.

A data processing unit 193 performs processing in which the terminal device 10 performs computation on data whose input has been accepted, in accordance with the application program 181, and outputs the computation result to a memory 15 or the like.

A presentation control unit 194 controls an output device 14 in order to present to a user information provided from the server 20. Specifically, for example, the presentation control unit 194 causes information transmitted from the server 20 to be displayed on a display 141. Further, the presentation control unit 194 causes information transmitted from the server 20 to be output from a speaker 172.

An EMR template acquisition unit 195 acquires the electronic medical record (EMR) template 2024 stored in a storage unit 202 of the server 20 and stores it in the storage unit 180 as the EMR template 182.

A speech-recognition unit 196 inputs speech data 183, which has been input by a healthcare worker via the microphone 171, into the learned model 187 on the basis of the speech data 183, and thereby acquires speech-recognition data 184 as an output result.

At this time, it is preferable that the speech-recognition unit 196 perform speech-recognition on the speech data 183 corresponding to the input items and input content of the EMR template 182 included in the speech data 183, determine to which input item the speech data 183 pertains, and, based on this determination result, select, from among multiple learned models 187 stored in the storage unit 180, a learned model 187 suitable for the input item and input content that are the determination result, and perform speech-recognition processing based on the selected learned model 187.

When performing speech-recognition processing based on the speech data 183, the speech-recognition unit 196 records a point in time at which the speech-recognition processing on the speech data 183 was performed, that is, a playback position of the speech data 183. The speech-recognition unit 196, together with the presentation control unit 194, then presents the playback position of the speech data 183 in a state visible to the healthcare worker operating the terminal device 10 via the display 141 of the output device 14. The form of display of the playback position is arbitrary; as one example, a seek bar format can be used. In addition, on the playback position display screen, a button or the like that accepts an instruction input for playback start/pause of the speech data 183 is displayed, and when an operation input of the button is given by the healthcare worker who is the operator of the terminal device 10, playback start/pause of the speech data 183 is performed. In conjunction therewith, speech-recognition processing by the speech-recognition unit 196 is started/paused.

Here, input items and input content of the EMR template 182 include items such as a hospital name and the names of a patient's family members. For example, although ideally the names of a patient's family members should be written in kanji, rendering them in katakana is not necessarily incorrect. As a result of speech-recognition processing by the speech-recognition unit 196, it is difficult to identify the correct kanji representation down to a specific character string, for example to distinguish among homophones such as Watanabe Akira written as . . . , . . . , or other different kanji having the same pronunciation. Further, time is required to correct misrecognitions. Therefore, it is preferable that the speech-recognition unit 196, for a portion determined to correspond to a personal name in the speech data 183, retain the portion in a katakana or hiragana representation. At the same time, in another UI, candidates for how to change the katakana representation into kanji are displayed and a correction is induced by click or the like, thereby enabling an input that changes the katakana representation into a specific kanji representation. If a unique kanji is identifiable in past correct data, conversion may be performed in advance and displayed. Also, past correction content may be stored and applied automatically. An instruction for correction can be given by voice; after a specific wakeup word, a designation such as “kanji conversion: the shou of Showa (first character)” may be spoken.

Further, both extraction of a tooth and removal of sutures are read aloud as “bassi” in Japanese medical terminology, but the former is a term frequently used in dentistry and the latter is a term frequently used in surgery. Both may be treated as “bassi” during learning, and, for each departmental terminal, a function may be provided that prompts selection of a correction, or automatically inserts a correction based on the department.

An input item identification unit 197 refers to the speech-recognition data 184 that is an output result of the speech-recognition unit 196, collates this speech-recognition data 184 with the designated medical term data 185, and identifies input items of the EMR template included in the speech-recognition data 184. The input item identification unit 197 then identifies, from the speech-recognition data 184 based on the speech data 183 that the healthcare worker spoke subsequent to the identified input item, input content that is to be input/corrected/appended. That is, in the speech data 183 (and hence in the speech-recognition data 184), the input item and the input content are spoken continuously (here, “continuously” means such a time interval that it can objectively be recognized that the healthcare worker who is the speaker has uttered, in one sequence, the input item and the input content that is content to be input/corrected/appended corresponding to this input item. That is, not only when there is no time interval at all, but as long as it can objectively be recognized that the contents are uttered in one sequence, it may fall within the category of continuous). The input item identification unit 197 recognizes that they are spoken continuously, and, based on this continuity, extracts, from the speech-recognition data 184, the input content for which the healthcare worker who is the speaker has instructed input/correction/appending, and extracts candidates for input/correction/appending of content based on the speech-recognition data 184.

Further, the input item identification unit 197 may, based on the continuity described above, extract multiple candidates for input items included in the speech data 183 (speech-recognition data 184) and present, to the operator (that is, the healthcare worker) of the terminal device 10, an inquiry as to which input item the correction/appending instruction pertains. Thereafter, a record content recording unit 198 accepts a selection instruction of an input item from the operator of the terminal device 10 and finalizes the correction/appended content. As one example, the result of speech-recognition may be searched by a heuristic search algorithm or the like to search for kanji representation candidates, and if there are multiple candidates, they may be displayed to prompt a kanji conversion.

Here, the speech data 183 of the healthcare worker who is the speaker may be considered to have, as a single unit, the input item that is a noun, a particle such as “wa” (topic marker) that connects to the input item, and the input content that is the target of correction/appending and that is spoken subsequent to this particle. Therefore, the input item identification unit 197, using a predetermined particle (as one example, “wa”) as a key in advance, infers that the speech data 183 spoken before this particle corresponds to an input item and performs identification of the input item, and determines that the speech data 183 spoken subsequent to the particle (for example, “wa”) and spoken continuously with the identified input item is input content associated with the input item and is input content that the speaker has spoken for input/correction/appending, and, based on the speech-recognition data 184, identifies the input content that is a target of correction/appending.

Further, since the input item identification unit 197 can specify up to the input content from the continuity between the input item and the particle, if the input content is expressible in the form of a certain set of options (that is, if the input content is in an option format), candidates (options) for the input content can be prepared in advance, and the candidates for the input content can be presented to the operator (the healthcare worker who is the speaker) to request selection of a candidate of the input content.

In the present embodiment, the EMR template 182 is stored in the storage unit 180 of the terminal device 10, and in the EMR template 182, the input content is in an option format, and the content (description) of the options themselves is also specified. Therefore, the input item identification unit 197 can easily identify, by using designated medical terms included in the speech-recognition data 184, the option corresponding to the speech-recognition data 184 relating to the input content.

The input item identification unit 197 may, when a designated medical term is spoken by a user at the time of speech input, change a screen display so that a list of the options is visible when the designated medical term is identified, or highlight the option or the designated medical term, or scroll the screen to a place where the options are visible.

Further, the input item identification unit 197 records audio at the time of speech input, and, when an item name is clicked on the UI, playback can be started from a starting portion of the audio used at the time of the relevant speech input, thereby enabling confirmation of whether correct speech has been input. When, during audio playback, a designated medical term is recognized, the screen can be scrolled to that item or the like so that it is possible to confirm whether the input is correct.

Thereafter, the record content recording unit 198 accepts a selection instruction of input content from the operator of the terminal device 10, finalizes the input/correction/appended content, that is, the record content, to the EMR template 182, and generates EMR template data 188.

The operation of the input item identification unit 197 described above can also be realized as an operation of the speech-recognition unit 196 by providing, in the teacher data 186, patterns (for example, associations of input items, particles, and input content, and candidates for input content) and causing the learned model 187 to perform learning based on the teacher data 186.

Further, when identifiers, for example numbers, for identifying respective input items are appended to input items of the EMR template 2024 stored in the storage unit 202 of the server 20, and these identifiers are also included in the EMR template 182, the input item identification unit 197, if it determines that an identifier of an input item is included in the speech-recognition data 184, may identify, based on this identifier, the input item that is a target of input/correction/appending, and further determine that input/correction/appended content of the input content associated with the identified input item is included in the speech-recognition data 184, and identify correction/appended content of the input content.

Further, information (not shown) that specifies and limits words or types of characters that can be input as input content can be stored in the storage unit 180. In this case, when identifying input content from the speech-recognition data 184, the input item identification unit 197 determines whether text data included in the speech-recognition data 184 matches the specified and limited information, and if it matches, may identify it as an input of input content that is a target of input/correction/appending. As one example, if the input item is “patient contact,” the input content needs to be a string of numbers. Accordingly, a portion of the speech-recognition data 184 that is a string of numbers can be identified as input content. Alternatively, the speech-recognition unit 196 may perform speech-recognition processing on the basis that, if the input item is “patient contact,” input content spoken subsequent to this input item must be a string of numbers, based on such information.

Further, when the input content is an option, if a designated medical term included in one of the options is included in the speech-recognition data 184, the input item identification unit 197 may deem that speech-recognition data 184 spoken by the healthcare worker who is the speaker for instructing input/correction/appending represents this option, and identify the input content that is a target of input/correction/appending. Further, when the input item identification unit 197 has identified an input item based on the speech-recognition data 184, it may present options of input content associated with the identified input item. Thereafter, the record content recording unit 198 accepts a selection input from the healthcare worker who is the operator, and finalizes, based on the accepted selection input, the input/correction/appended content, that is, the record content, into the EMR.

The input item identification unit 197 may also allow designation by an item serial number linked to an input item. For example, instead of specifying “there is no sleep disorder,” the input item may be specified based on an item number name such as “item number 34: none.” In such a case, a display screen displays which item corresponds to item number 34, thereby guiding speech input.

Here, the healthcare worker who is the speaker utters a predetermined word that indicates a delimiter of an input item and input content, for example “new line,” and, as a result of speech-recognition by the speech-recognition unit 196, when the predetermined word is included in the speech-recognition data 184, the input item identification unit 197 determines that a delimiter of an input item and input content has been input by this word.

When a predetermined word is included in the speech-recognition data 184 as a result of recognition, the input item identification unit 197 further performs identification of input items and input content for the speech-recognition data 184 after the word serving as the delimiter. In this way, even if the speaker has spoken in one continuous utterance, identification of input items and input content can be reliably performed. Further, the EMR template 182 may have a table structure. For example, when inputting past medical history, the input item identification unit 197 can structure table-structured data by the speaker uttering in a certain format. For example, when it is uttered, “In 2000, diagnosis of hypertension, treatment at Nogaki Hospital, currently, under continued treatment. New line. In 2010, diagnosis of dyslipidemia, treatment at this hospital, currently cured.” First, by “as for past medical history,” it is recognized that past medical history information will follow. In this example, there are two disease names in the past medical history. “First disease: onset year 2000, disease name hypertension, treatment hospital Nogaki Hospital, transcription under treatment.” “Second disease: onset year 2010, disease name dyslipidemia, treatment hospital this hospital, transcription cured,” is understood. Although it is also possible to input one by one as “Past medical history 1: hypertension; onset year of past medical history 1:2000; treatment hospital of past medical history 1: Nogaki Hospital,” by performing speech input of table information in the format above, it becomes possible to reduce utterance volume and save labor.

The input item identification unit 197, on the UI, displays something like “(Period: at age XX/around 20XX/20XX˜), (disease name) (diagnosis), at (hospital name) (treatment: surgery/oral medication/inpatient treatment/(treatment name) treatment), currently, (transcription: cured/recovering/under treatment)),” thereby enabling the speaker to smoothly input the table-structured information described above.

The speech-recognition unit 196 and the input item identification unit 197 may, during each of the tasks of generating the speech-recognition data 184 based on the speech data 183 and identifying input items and input content based on the speech-recognition data 184, display progress of these tasks on the display 141. As one example, the speech-recognition unit 196 and the input item identification unit 197 may textually display the speech-recognition data 184, and display the textually displayed speech-recognition data 184 together with the identified input items and input content. As one example, the textual display may be displayed as a floating text box and, after being textually displayed as the speech-recognition data 184 as a result of speech-recognition processing by the speech-recognition unit 196, when the input items and input content are identified by the input item identification unit 197, the text box may be displayed so as to move to a location of the identified input items or the like.

In particular, the speech-recognition unit 196 and the input item identification unit 197 may, as one example, divide the same screen of the display 141 vertically or horizontally, display the EMR template 182 on one side, and enumerate and display pairs of input items and input content in a vertical or horizontal direction on the other side. With such a display mode, because the pairs of input items and input content are enumerated in a vertical or horizontal direction, as the identification work by the input item identification unit 197 sequentially progresses, the textual display relating to the identified input items or the like sequentially proceeds in one of the vertical or horizontal directions. Then, in association with the progress of the textual display, a corresponding portion (that is, an input item) of the EMR template 182 may also be sequentially scrolled vertically or horizontally.

A record content recording unit 198 accepts, for the input items and input content identified by the input item identification unit 197 and presented to the operator of the terminal device 10, input (including selection input and inputs such as accept/cancel) from the operator, and, based on the accepted input, inputs/corrects/appends the input items and input content and finalizes the input of these input items or the like. The record content recording unit 198, using the finalized input items and input content, finalizes EMR template data 188 that is input/correction/appended content to the electronic medical record, that is, record content. The record content recording unit 198 temporarily stores the finalized EMR template data 188 in the storage unit 180.

At this time, the record content recording unit 198, for each of the input items or input content identified by the input item identification unit 197, presents to the operator a selection of whether to perform a correction/appending, and, based on a selection instruction from the operator, inputs the input items and.

input content. In particular, when input content to be recorded already exists (that is, when input content to be recorded already exists for an input item identified by the input item identification unit 197), the record content recording unit 198 may cause a message to be displayed on the display 141 to the healthcare worker operating the terminal device 10, the message confirming that input content already exists and further asking whether the input content may be corrected/appended. Then, the record content recording unit 198 may wait for an operation input instructing correction/appending from the healthcare worker and perform correction/appending of the input content. Further, when the input item/input content identified by the input item identification unit 197 is not what the operator intends, the record content recording unit 198 may refer to the speech-recognition data 184 stored in the storage unit 180 and instruct the input item identification unit 197 to redo the identification operation. Further, when the input content identified by the input item identification unit 197 is what is intended, but an input item associated with the input content differs from the operator's intention, the record content recording unit 198 may refer to the speech-recognition data 184 and accept an input from the operator to associate the identified input content with a different input item.

An EMR template data transmission unit 199 transmits the EMR template data 188 finalized by the record content recording unit 198 to the server 20.

### <1.2 Functional Configuration of Server 20>

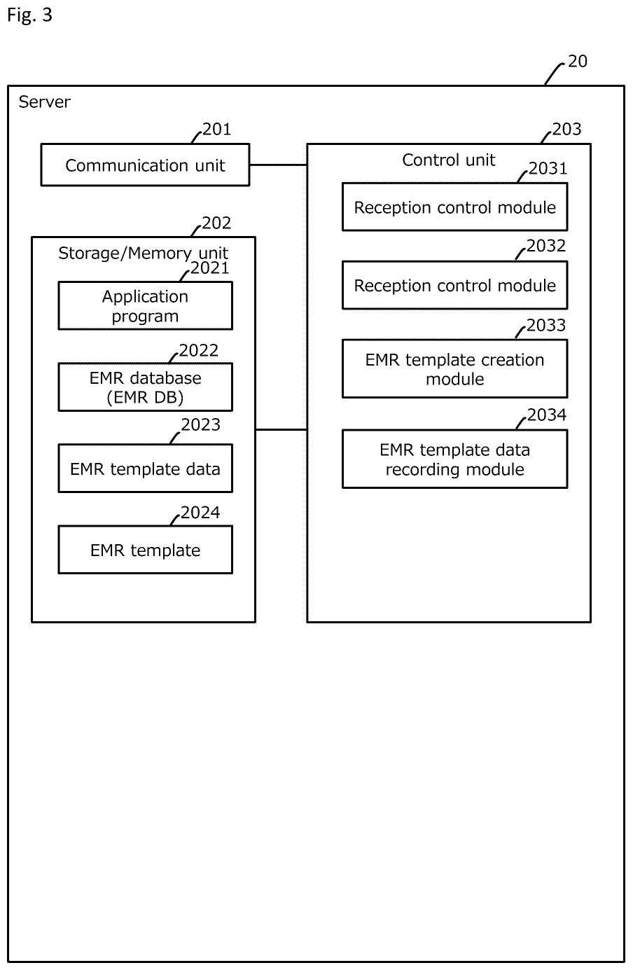

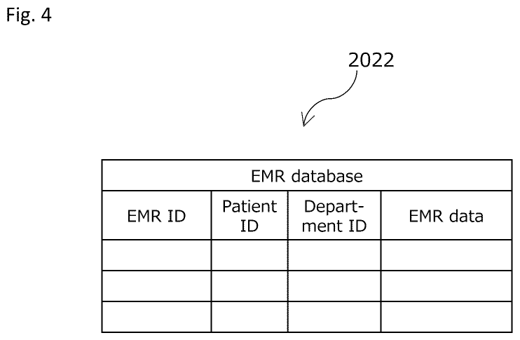

FIG. 3 is a diagram illustrating an example of a functional configuration of the server 20. As shown in FIG. 4, the server 20 functions as a communication unit 201, a storage unit 202, and a control unit 203.

A communication unit 201 performs processing for the server 20 to communicate with an external device.

A storage unit 202 includes, for example, an EMR DB 2022, EMR template data 2023, and an EMR template 2024.

An EMR DB 2022 is a database for managing electronic medical record data relating to patients who have visited a medical facility that uses the server 20. The EMR DB 2022 may manage electronic medical record data of multiple medical facilities. Details will be described later.

The EMR template data 2023 is EMR template data 188 generated by the terminal device 10, and by being incorporated into the EMR DB 2022 constitutes a part of record content of an electronic medical record. The EMR template data 2023 has input items and input content associated with the input items. Although the data format of the EMR template data 2023 is not particularly limited, the EMR template data 2023 of this embodiment is obtained by converting data described in XAML (Extensible Application Markup Language) into a JSON (JavaScript Object Notation) format (JavaScript is a registered trademark). It is preferable that an identifier such as a string of numbers be assigned to the input items of the EMR template data 2023, and such an identifier also constitutes the EMR template data 2023.

An EMR template 2024 is a template when generating the EMR template data 2023. The EMR template 2024 is structured data that defines input items and input content associated with the input items. Although the data format of the EMR template 2024 is not particularly limited, the EMR template 2024 of this embodiment, similar to the EMR template data 2023, is obtained by converting data described in XAML into a JSON format. Similar to the EMR template data 2023, it is preferable that an identifier such as a string of numbers be assigned to the input items of the EMR template 2024, and such an identifier also constitutes the EMR template 2024.

An identifier for identifying each individual EMR template 2024 is associated with each EMR template 2024. As one example, the identifier of the EMR template 2024 is a string of numbers having a predetermined number of digits. The identifier of the EMR template 2024 is assigned by an EMR template creation module 2033 described later.

A control unit 203 is realized by a processor 29 reading an application program 2021 stored in the storage unit 202 and executing instructions contained in the application program 2021. By operating in accordance with the application program 2021, the control unit 203 functions as a reception control module 2031, a transmission control module 2032, an EMR template creation module 2033, and an EMR template data recording module 2034.

A reception control module 2031 controls processing in which the server 20 receives signals from an external device in accordance with a communication protocol.

A transmission control module 2032 controls processing in which the server 20 transmits signals to an external device in accordance with a communication protocol.

By sharing, among multiple medical facilities, an electronic medical record template accompanied by a speech-recognition engine specialized for template input and a template input guide UI created at one medical facility, it becomes possible to use high-accuracy speech-recognition throughout Japan. To achieve this sharing, the EMR template creation module 2033 performs an import while maintaining an association between the electronic medical record template, the electronic medical record template data, and speech-recognition. Although, programmatically, each item of the template is recognized by a separate identifier accompanying each item, in some cases an identifier is automatically assigned upon import, making it difficult to maintain the association. In such a case, immediately after import, a correspondence table of identifiers before and after import is created based on the fact that a file exported after import has position information and item information matching before import, and using this correspondence table, an association is made between the identifiers of each item of the template after import and designated medical terms before import. In this way, speech input can be performed using identifiers of each item of templates of respective medical facilities. Also, it is possible to address this by adding, to an import tool of the template, a mechanism that maintains identifiers after confirming at the time of import that identifiers of added items do not conflict with other identifiers.

In this embodiment, multiple answer candidates (candidates of input content) of interview questions may be associated with an input item. That is, the input content may be one answer candidate selected from among multiple answer candidates. Is stored in the storage unit 202.

An EMR template data recording module 2034 records, in the storage unit 202, EMR template data 2023 based on EMR template data 188 acquired from the terminal device 10.

At this time, when EMR template data 2023 already exists for a particular patient (and further in a particular medical department), the EMR template data recording module 2034 may display a screen that confirms with an operator of the terminal device 10 or an administrator of the server 20 whether EMR template data 188 acquired from the terminal device 10 is to overwrite, add to, or replace the existing EMR template data 2023, and request a confirmation input from the operator or the like. Then, in accordance with contents of the confirmation input, overwriting/adding/replacing or the like in the EMR template data 2023 may be performed.

In particular, patient profile information-such as, by way of example, the patient's address, sex, height, weight, and allergy information—is patient-specific information that is unlikely to change. Accordingly, it is preferable that the electronic medical record (EMR) template data recording module 2034 always perform a confirmation input (e.g., overwrite confirmation) with respect to the profile information.

Here, when inputting the EMR template data 2023, it is possible to reduce input effort by initially populating (pre-filling) previous template input information from the electronic medical record. In such a case, however, it may become unclear which portions were corrected as a result of speech-recognition and which portions are merely initial input values. By differentiating, for example by color, among (i) portions for which speech input is not possible, (ii) portions corrected by speech input, and (iii) portions for which speech input has not been performed, the system can indicate to the user whether additional input (supplementation) is necessary or unnecessary.

Further, to reduce the effort of inputting choices, data of an electronic questionnaire or data of a personal health record (PHR) may be used. In addition, at that time, structured data entered on a smartphone may be converted into a QR code (registered trademark), read by a QR code reader provided at a terminal on the hospital network, and transferred onto the hospital network while remaining structured.

In that case, three inputs will exist: information from the medical record, information from the electronic questionnaire, and information from speech-recognition. By changing the display—for example, by varying highlight colors—to indicate, for each item, which information is the source, and whether a correction exists, the system may make the origin of the data apparent to the user. Additionally, as part of the mechanism, information indicating whether an input item is speech-recognition-capable or speech-recognition-incapable can be displayed by shading or the like.

Further, the EMR template data recording module 2034 may, based on the contents (particularly the input content) of the EMR template data 2023, notify a medical fee reimbursement calculation module (not shown) that the medical fee reimbursement may change due to the input content. For example, if the input content of the EMR template data 2023 includes content indicating that the patient corresponding to the EMR template data 2023 is a dialysis patient, the module may notify that the inpatient medical fee reimbursement should be appropriately changed.

Further, the EMR template data recording module 2034 may generate a document that a healthcare worker should provide based on the EMR template data 2023. Typical examples of such processing include cases of a referral letter to be provided to another medical facility, a discharge summary, or an admission summary, generated based on the EMR template data 2023. The matters and content to be described in the referral letter are based on the EMR template data 2023, and the EMR template data recording module 2034 generates text data to be described in the referral letter based on the EMR template data 2023. In this case, the EMR template data recording module 2034 may use the structured data as input items as a prompt for a document generation task of a large language model, such as a large language model (LLM), and prepare a draft of the referral letter or a summary draft.

In that case, the EMR template data recording module 2034 allows a user to select, based on the chief complaint/purpose of referral, content that is desirable to include in a referral letter or summary from the structured data, or automatically selects such content using machine learning, and, using the selected structured data as input items, utilizes a document template or uses the structured data as a prompt for a large language model to create a referral letter document, a summary, or a report for a pharmaceutical company. In that case, a function can be implemented to automatically select a template from among a plurality of document templates based on the selected structured data, and the structured data can be categorized and re-organized per category to create structured data based on categories. Thus, the EMR template data recording module 2034 can generate medical documents such as a referral letter, a discharge summary/admission summary, and a report for a pharmaceutical company, based on the EMR template data 2023.

The output of a document generation task using a large language model may be replaced with incorrect information. Since a change in values such as test names or test values in a referral letter causes a significant problem in reliability, it becomes necessary to confirm that substitution has not occurred. Therefore, it becomes important that the EMR template data recording module 2034 provide, as a user interface, a means that allows easy confirmation that numbers and values are not offset.

In association with the item names of the template, highlight keywords may be recorded, and by creating a correspondence while highlighting the generated document, a user interface that displays where each description of the template is written is useful for confirmation. Further, confirmation becomes difficult in a case where, for example, a value is replaced such that a numerical value changes from 1.0 to 1.1. However, for example, when an expression such as 1.0 occurs multiple times within the same sentence, it is difficult to identify a correspondence by character matching.

Accordingly, in order to prevent numerical values from being replaced, the EMR template data recording module 2034 may create a prompt by changing, to values that are difficult to collide, the values presented in the prompt, for example, changing a first Na value to 0.0000001 and a second K value to 0.0000002, and may perform a document generation task using the prompt. The module can then generate the document while maintaining correspondence by associating 0.0000001 in the generated document with the original actual Na value, associating 0.0000002 with the actual K value, and simultaneously substituting the numbers.

Further, by converting the collision-resistant value into a collision-resistant format notation such as [Na value], [K value], it becomes possible to keep the correspondence unique. In one example, a sentence such as: “The results of the electrolyte test during hospitalization were Na [Na value] and K [K value].” is created. In this way, the completed generated sentence can be used like a “sentence template,” and, from the next time onward, a document creation task can be performed without executing document generation, eliminating the need for re-confirmation of value misalignments. Moreover, it becomes easy to confirm that the intended numbers and information are properly described in the completed generated sentence.

Further, in one example, structured information may be consolidated in accordance with a category such as test values. In one example, for structured data in which an item name “Blood test result: Na” has a value of “130 meq/l” and an item name “Blood test result” has a value of “K5.0 meq/l” as two separate pieces, data indicating that both belong to a category of electrolyte test may be prepared separately, and the item name “Electrolyte test result” may be given a value with a structure of “Na130 meq/l, K5.0 meq/l” so that a sentence template such as: “The results of the electrolyte test on the day were [electrolyte test result].” becomes possible. By consolidating into structured data summarized in one line such as “Electrolyte test result: Na130 meq/l, K5.0 meq/1,” the sense of coherence of the generated sentence may be increased. A template sentence such as: “The electrolyte test results during hospitalization were [electrolyte test result].” also becomes possible.

Additionally, as a document generation task using a large language model, a prompt may be created that fuses: (i) a sentence instructing the acquisition of additional questioning (inquiry) text to a patient and response choices thereof; and (ii) structured sentences selected from the above template structured sentences. Based on a response obtained by running the document generation task using the prompt, a user interface may be created that standardizes the terminology of the response content, and allows a patient to input, as a selectable electronic questionnaire, standardized selectable input content with unified terminology, and a user interface may be created that allows the patient to input additional structured sentences with unified terminology. Further, when inputting test values, a link to the test result report may be appended to clarify the basis.

### 2 Data Structure

FIG. 4 is a diagram illustrating a data structure of a database stored by the server 20. FIG. 4 is merely an example and does not exclude data not described.

The database shown in FIG. 4 refers to a relational database and is for managing, in an associated manner, data sets called tabular tables structurally defined by rows and columns. In a database, a table is called a table, a column of a table is called a column, and a row of a table is called a record. In a relational database, relationships between tables can be set and tables can be associated.

Usually, in each table, a column serving as a primary key for uniquely identifying a record is set, but setting a primary key for a column is not mandatory. The control unit 203 of the server 20 can cause the processor 29, in accordance with various programs, to execute addition, deletion, and update of records to a specific table stored in the storage unit 202.

FIG. 4 is a diagram illustrating a data structure of the electronic medical record DB 2022. As shown in FIG. 4, each record of the electronic medical record DB 2022 includes, for example, an item “EMR ID,” an item “Patient ID,” an item “Department ID,” and an item “EMR data.” Each item of the electronic medical record DB 2022 is input by the EMR template data recording module 2034 when the EMR template data recording module 2034 generates the EMR template data 2023. The information stored in the electronic medical record DB 2022 can be changed/updated as appropriate.

The item “EMR ID” is an ID for identifying an electronic medical record managed by the system 1 of the present embodiment (particularly the server 20). The item “Patient ID” is an ID for identifying a patient related to medical information managed by the electronic medical record identified by the item “EMR ID.” The item “Department ID” is an ID for identifying a department related to medical information managed by the electronic medical record identified by the item “EMR ID.” The item “EMR data” is information relating to a file name of the EMR template data 2023 corresponding to the electronic medical record identified by the item “EMR ID.”

### 3 Operation Example

Hereinafter, an example of operation of the terminal device 10 and the server 20 will be described.

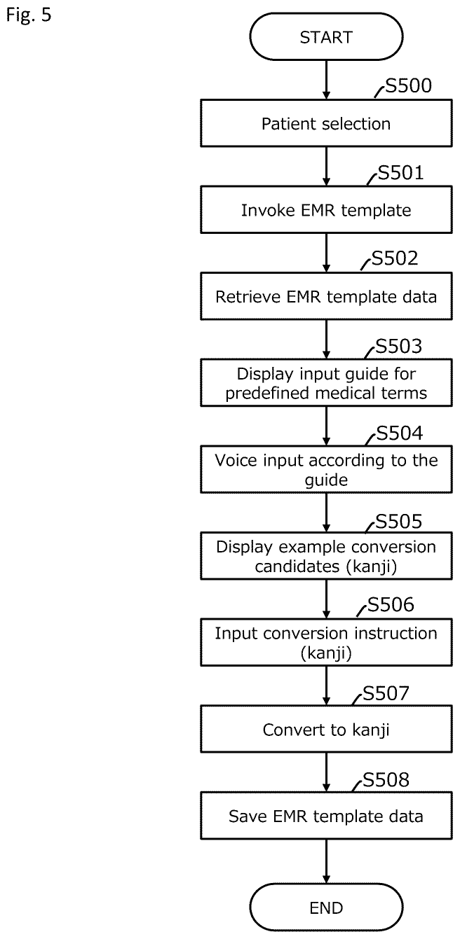

FIG. 5 is a flowchart illustrating an example of operation of the terminal device 10. FIG. 5 is a flowchart showing an example of operation when an operator of the terminal device 10 performs input/correction/addition of the EMR template data 188 by speech input.

First, in step S500, the control unit 190 selects a patient relating to the EMR template data 188 to be input, corrected, or added. Specifically, for example, the control unit 190 accepts, via the input device 13, a patient selection input from an operator of the terminal device 10.

Next, in step S501, the control unit 190 calls (retrieves) from the storage unit 180 of the terminal device 10 the EMR template 182 that is a source (base) EMR template 182 for the EMR template data 188 relating to the patient selected in step S500.

Next, in step S502, the control unit 190 calls (retrieves), from the storage unit 180 of the terminal device 10, the EMR template data 188 relating to the patient selected in step S500, among the EMR templates 182 stored in the storage unit 180 of the terminal device 10.

Next, in step S503, the control unit 190 causes an input guide of medically designated terms or the like, which is displayed as guidance for speech input by a user of the terminal device 10, to be displayed on the display 141 of the terminal device 10. Specifically, for example, the control unit 190 causes, via the input item identification unit 197, the input guide of medically designated terms or the like, which is displayed as guidance for speech input by the user of the terminal device 10, to be displayed on the display 141.

Next, in step S504, the control unit 190 accepts, via the microphone 171 of the speech processing unit 17, a speech input regarding input items and input content to be input to the EMR template data 188, in accordance with the input guide displayed in step S503. Specifically, for example, the control unit 190 accepts, via the speech-recognition unit 196, a speech input regarding input items and input content to be input to the EMR template data 188, in accordance with the input guide displayed in step S503, via the microphone 171 of the speech processing unit 17, and stores it in the storage unit 180 as speech data 183.

Next, in step S504, the control unit 190 performs speech-recognition processing on the speech data 183 accepted in step S504 and identifies, from this speech-recognition result, the input items and input content to be input, corrected, or added. Specifically, for example, the control unit 190 performs, via the speech-recognition unit 196, speech-recognition processing on the speech data 183 accepted in step S504 to obtain speech-recognition result data 184. Then, based on this speech-recognition result data 184, the input item identification unit 197 identifies the content of the EMR template data 188 to be input, corrected, or added.

Next, the control unit 190 presents, on the display 141, the speech-recognition content that is the input items and the like identified in step S504. Specifically, for example, the control unit 190 presents, via the input item identification unit 197, on the display 141, the speech-recognition content that is the input items and the like identified in step S504.

Next, in step S505, the control unit 190 causes kanji conversion candidate examples to be displayed on the display 141, based on the speech-recognition result of step S504. Specifically, for example, the control unit 190 causes, based on the speech-recognition result of step S504, kanji conversion candidate examples to be displayed on the display 141.

Speech-recognition content is normally expressed in hiragana or katakana. Accordingly, in step S506, the control unit 190 accepts, via the input device 13, an instruction input for kanji conversion regarding the speech-recognition content expressed in hiragana or the like and made by a user of the terminal device 10. Specifically, for example, the control unit 190 accepts, via the input item identification unit 197, an instruction input for kanji conversion regarding the speech-recognition content expressed in hiragana or the like and made by the user of the terminal device 10, via the input device 13.

Next, in step S507, the control unit 190 accepts, via the input device 13, the instruction input for kanji conversion made by the user of the terminal device 10 in step S506, and confirms (finalizes) the kanji conversion result based on this selection input. Specifically, for example, the control unit 190 accepts, via the input item identification unit 197, the instruction input for kanji conversion made by the user of the terminal device 10 in step S506, via the input device 13, and confirms the kanji conversion result based on this selection input.

In step S508, the control unit 190 finalizes (confirms) the content of the EMR template data 188 with the kanji conversion result identified in step S507. Specifically, for example, the control unit 190, via the record content recording unit 198, finalizes the content of the EMR template data 188 with the kanji conversion result identified in step S507. Thereafter, the EMR template data transmission unit 199 transmits the finalized EMR template data 188 to the server 20, and the EMR template data recording module 2034 of the server 20 stores, in the storage unit 202, the EMR template data 2023 transmitted from the terminal device 10.

Thereafter, the control unit 203 of the server 20 imports the EMR template data 2023 input in step S506 into the EMR DB 2022. Specifically, for example, the control unit 203, via the EMR template data recording module 2034, imports the EMR template data 2023 transmitted from the terminal device 10 into the EMR DB 2022.

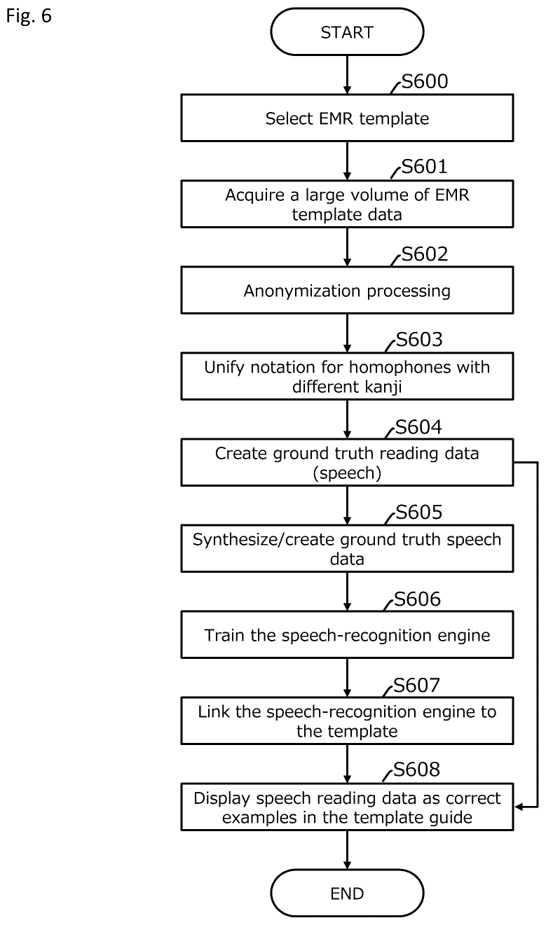

FIG. 6 is a flowchart illustrating an example of operation of the server 20. FIG. 6 is a flowchart showing an example of operation when an operator of the server 20 creates an EMR template 2024 linked to a speech-recognition engine.

First, in step S600, the control unit 203 selects an EMR template that is the source for the EMR template 2024 to be created in FIG. 6. Specifically, for example, the control unit 203, via the EMR template creation module 2033, selects an EMR template that is the source for the EMR template 2024 to be created in FIG. 6. The EMR template selected in step S600 may be an EMR template 2024 stored in the storage unit 202 of the server 20 or may be stored in an external data server (not shown in FIG. 1).

Next, in step S601, the control unit 203 acquires a large quantity of EMR template data to be used as learning data of the speech-recognition engine to be linked to the EMR template 2024 to be created in FIG. 6. Specifically, for example, the control unit 203, via the EMR template creation module 2033, acquires a large quantity of EMR template data to be used as learning data of the speech-recognition engine to be linked to the EMR template 2024 to be created in FIG. 6. The EMR template data acquired in step S601 may be EMR template data 2023 stored in the storage unit 202 of the server 20 or may be stored in an external data server (not shown in FIG. 1).

The EMR template data acquired in step S601 is data that has been input by a doctor or healthcare worker based on any EMR template 2024 and includes profile information such as the patient's name. Accordingly, in step S602, the control unit 203 performs anonymization processing mainly on the profile information in the EMR template data acquired in step S601. Specifically, for example, the control unit 203, via the EMR template creation module 2033, performs anonymization processing mainly on the profile information in the EMR template data acquired in step S601.

Next, in step S603, the control unit 203 performs, on kanji notations included in the EMR template data acquired in step S601, normalization of homophonic different kanji notations (homophones represented by different kanji).

The control unit 203 then performs normalization of homophonic different kanji notations on the kanji notations included in the EMR template data acquired in step S601. Specifically, for example, the control unit 203, via the EMR template creation module 2033, performs normalization of homophonic different kanji notations on the kanji notations included in the EMR template data acquired in step S601.

In step S604, the control unit 203 creates correct speech reading data based on the result of normalization of homophonic different kanji notations performed in step S603. Specifically, for example, the control unit 203, via the EMR template creation module 2033, creates correct speech reading data based on the result of normalization of homophonic different kanji notations performed in step S603. Next, in step S605, the control unit 203 synthesizes/creates correct speech data based on the correct speech reading data generated in step S604. Specifically, for example, the control unit 203, via the EMR template creation module 2033, synthesizes/creates correct speech data based on the correct speech reading data generated in step S604.

Then, in step S606, the control unit 203 performs learning (training) of the speech-recognition engine (combination of teacher data and learning model) using the correct speech data created in step S605. Specifically, for example, the control unit 203, via the EMR template creation module 2033, performs learning of the speech-recognition engine (combination of teacher data and learning model) using the correct speech data created in step S605.

Next, in step S607, the control unit 203 links (associates) the speech-recognition engine trained in step S606 with the EMR template called in step S600.

Specifically, for example, the control unit 203, via the EMR template creation module 2033, links the speech-recognition engine trained in step S606 with the EMR template called in step S600. Further, the EMR template creation module 2033 of the control unit 203 links speech-recognition input word candidates with medically designated terms/selectable options/input items of the EMR template.

Then, in step S608, the control unit 203 displays, in a guide of the EMR template, the correct speech reading data generated in step S604 as a correct example. Specifically, for example, the control unit 203, via the EMR template creation module 2033, displays, in a guide of the EMR template, the correct speech reading data generated in step S604 as a correct example. Thereafter, the processing returns to step S604, and the processing from creation of the correct speech reading data to display of the correct example is repeated.

In this manner, as explained in the flowchart of FIG. 6, in the system 1 of the present embodiment the speech-recognition engine is trained based on the input results of the EMR template data that have already been entered. Therefore, it is possible to associate, with the EMR template, a speech-recognition engine that is more customized than speech-recognition performed by a general-purpose speech-recognition engine—in other words, a speech-recognition engine whose speech-recognition accuracy has been improved specifically in the input of the EMR template. As a result, by using an EMR template to which the speech-recognition engine has been linked, the input operation using the EMR template can be performed with high accuracy.

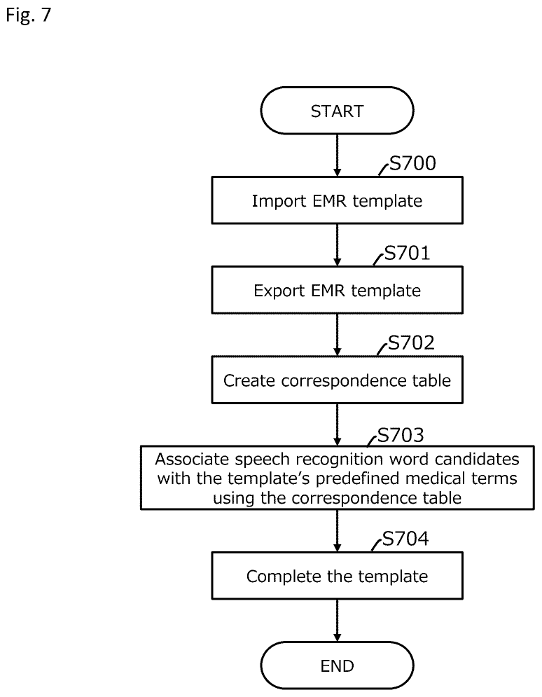

FIG. 7 is a flowchart illustrating an example of the operation of the server 20. FIG. 7 is a flowchart showing an example of the operation performed when an operator of the server 20 exports an EMR template, mainly to provide it to another medical facility, based on an already-existing EMR template.

In step S700, the control unit 203 imports the EMR template that is the source (base) of the EMR template to be exported. Specifically, for example, the control unit 203 imports, by the EMR template creation module 2033, the EMR template that is the source of the EMR template to be exported. The EMR template imported in step S700 may be the EMR template 2024 stored in the storage unit 202 of the server 20, or may be one stored in an external data server (not shown in FIG. 1).

Next, in step S701, the control unit 203 exports, based on the EMR template imported in step S700, an EMR template that is mainly provided to another medical facility. Specifically, for example, the control unit 203, by the EMR template creation module 2033, exports-based on the EMR template imported in step S700—an EMR template mainly provided to another medical facility.

Subsequently, in step S702, with respect to the EMR template imported in step S700 and the EMR template exported in step S701, the control unit 203 creates a correspondence table of these EMR templates based on the matching of input items, and more specifically, on the positional matching. Specifically, for example, the control unit 203, by the EMR template creation module 2033, creates a correspondence table of these EMR templates—regarding the EMR template imported in step S700 and the EMR template exported in step S701—based on the matching of input items, and more specifically, on the positional matching.

Subsequently, in step S703, the control unit 203 links the speech-recognition input word candidates to the designated medical terms/options/input items of the EMR template using the correspondence table created in step S702. Specifically, for example, the control unit 203, by the EMR template creation module 2033, links the speech-recognition input word candidates and the designated medical terms/options/input items of the EMR template using the correspondence table created in step S702. This linking operation may be performed by converting an identifier such as a number associated with an input item of the EMR template.

As a result, in step S704, the EMR template that is mainly provided to another medical facility can be completed.

### 4 Screen Examples

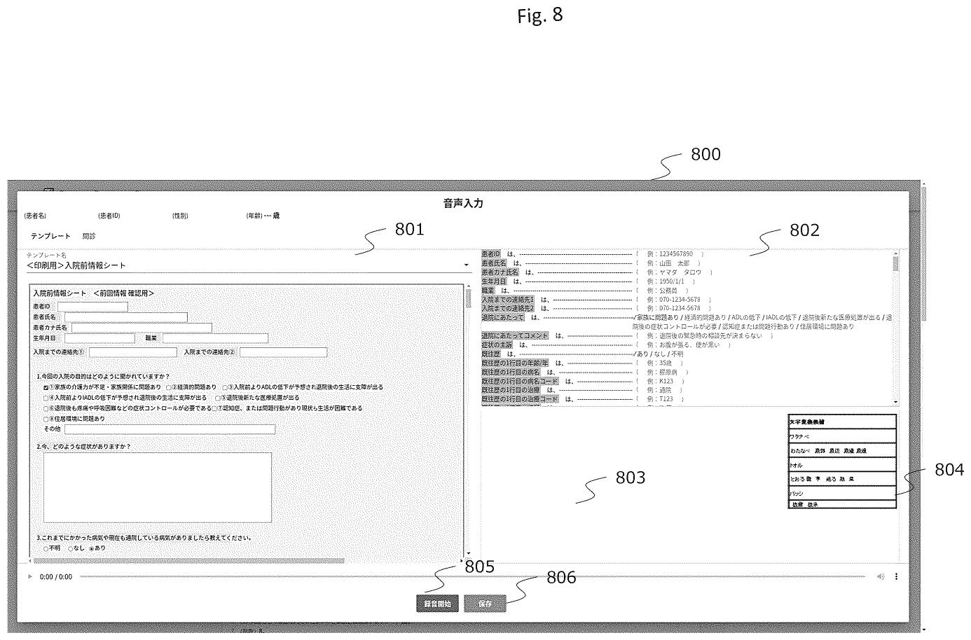

Hereinafter, an example of screens output to the terminal device 10 will be described with reference to FIGS. 8 to 15.

FIG. 8 is a diagram illustrating an example of a screen displayed on the display 141 of the terminal device 10 when an operator of the terminal device 10 performs input work of the EMR template data 2023.

On the left side of the screen 800 of the display 141 of the terminal device 10, a screen 801 is displayed that shows the input items of the EMR template 2024 stored in the storage unit 202 of the server 20 and the EMR template data 2023, which are input contents entered as a result of speech-recognition processing based on speech data 183 from the operator. An speech input guidance screen 802 is displayed in an upper right part of the screen 800 of the display 141, and a screen 803 that displays speech input results based on the speech data 183 is displayed in a lower right part of the screen 800. Further, a screen 804 for displaying kanji conversion candidates based on the speech input is superimposed and displayed on the screen 803. Furthermore, buttons 805 and 806 for instructing start of recording of the speech data 183 and saving of the speech data 183 are displayed at a lower portion of the screen 800.

The operator of the terminal device 10 issues an instruction to start recording the speech data 183 or an instruction to save the speech data 183 by performing an operation input such as clicking the buttons 805 and 806 by the input device 13.

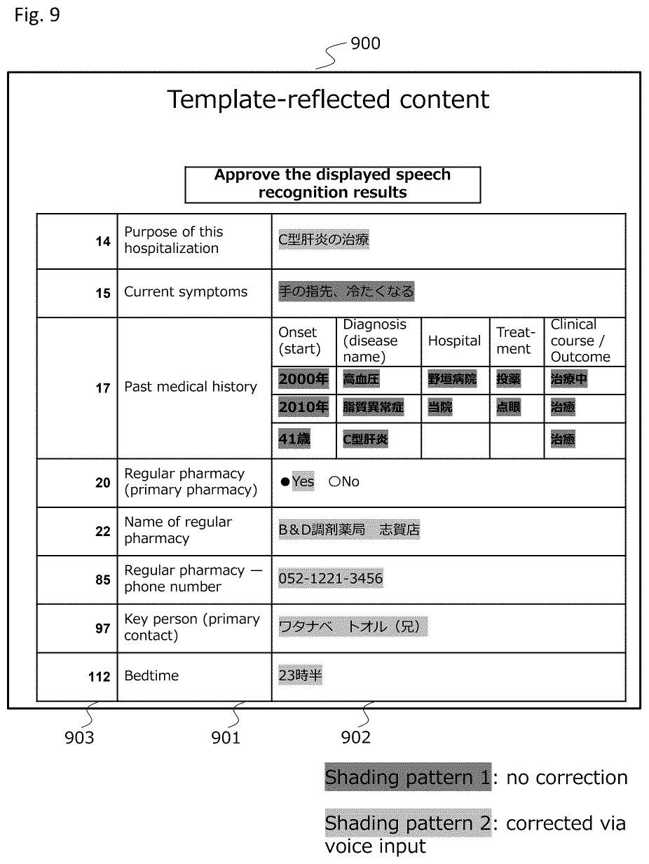

FIG. 9 is a diagram illustrating details of the screen 801 shown in FIG. 8. The screen 900 (801) is, as already explained, a screen that shows the input items of the EMR template 2024 and the EMR template data 2023, which are input contents entered as a result of speech-recognition processing based on speech data 183 from the operator.

On the screen 900 displayed on the display 141 of the terminal device 10, an input item 901 of the EMR template 2024 and input content 902 associated with this input item 901 are displayed. A number string 903 for identifying this input item 901 is also displayed for the input item 901. Along with the speech-recognition processing of the terminal device 10, speech input results are sequentially entered into the input content 902. In addition, in the input content 902 of the EMR template 2024, there are already entered matters, and (text continues in following paragraph).

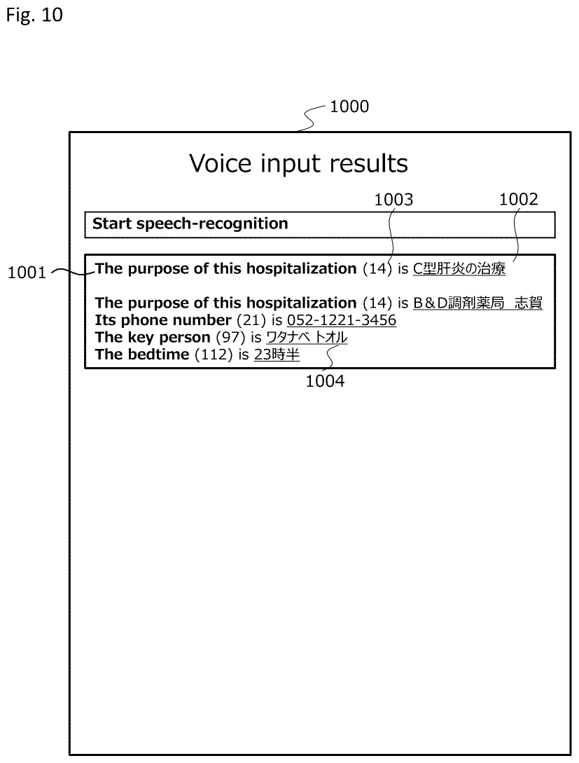

Matters have already been entered, and the speech input is being performed in order to append/modify the already-entered matters. As shown in FIG. 9, the already-entered matters are displayed in a specific color as “no modification,” and those for which an addition/modification has been made by the speech input are displayed in a color different from the already-entered matters. FIG. 10 is a diagram illustrating details of the screen 803 shown in FIG. 8. The screen 1000 (803) is, as already explained, a screen that displays speech input results based on the speech data 183.

On the screen 1000 of the display 141 of the terminal device 10, an input item 1001, which is speech-recognition data 184, and input content 1002 associated with this input item 1001 are displayed. A number string 1003 for identifying this input item 1001 is also displayed for the input item 1001. As shown in FIG. 10, the speech-recognition unit 196 and the input item identification unit 197 specify, from the speech-recognition data 184, a portion to be entered as the input content 1002, and an underline 1004 is attached to the portion specified as the input content 1002.

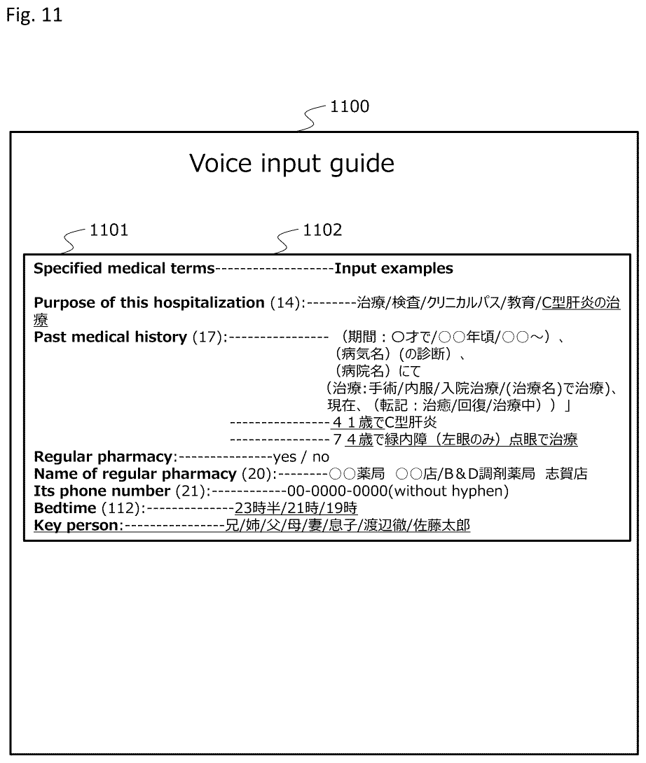

FIG. 11 is a diagram illustrating details of the screen 802 shown in FIG. 8. The screen 1100 (802) is, as already explained, a speech input guidance screen.

On the screen 1100 of the display 141 of the terminal device 10, an input item 1101 of the EMR template 2024 that includes a designated medical term, and example 1102 of input content to be entered for this input item 1101 are displayed. Further, when there are already-entered matters in the EMR template 2024, the already-entered matters are displayed in the location of the example 1102.

Note that playback of the speech data 183 may be started by the operator of the terminal device 10 performing a selection input, via the input device 13, of a display location of the input content in FIG. 9 or of the input item or input content shown in FIG. 10.

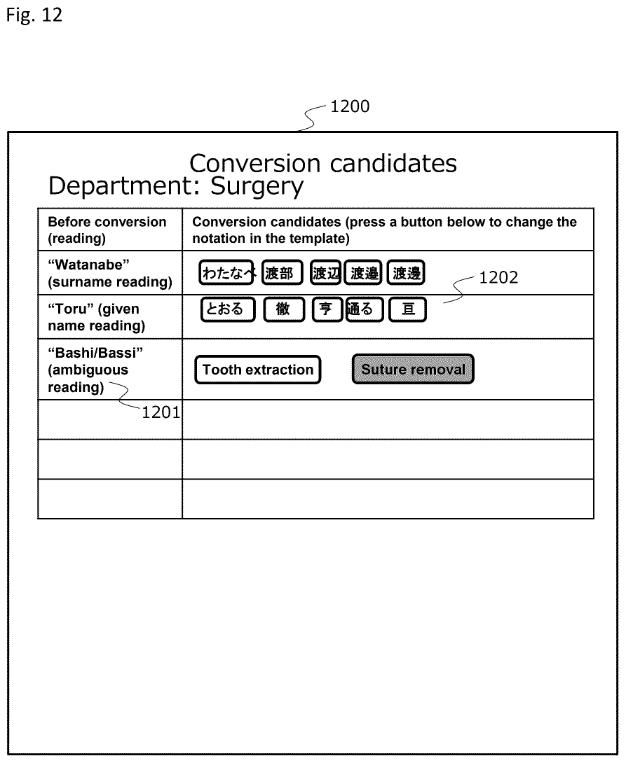

FIG. 12 is a diagram illustrating a screen that displays, when the operator of the terminal device 10 is performing speech input using the screen 800 shown in FIG. 8, kanji conversion candidate examples that are pop-up displayed on the screen 800.

On the screen 1200 of the display 141 of the terminal device 10, a hiragana notation 1201 before conversion at the time the speech-recognition unit 196 performs kanji conversion based on the speech data 183, and conversion candidate examples 1202, are displayed. The operator of the terminal device 10 confirms the kanji conversion by selecting any of the conversion candidate examples 1202 using the input device 13.

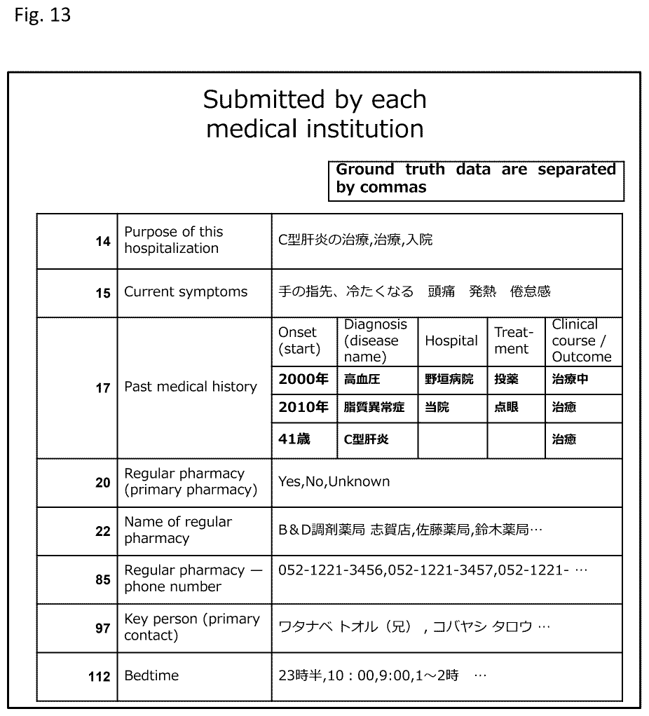

FIG. 13 is a diagram illustrating an example of EMR template data provided from another medical facility at the time of import of the EMR template. Since the configuration of the EMR template data is the same as that shown in FIG. 9, a detailed description is omitted. Because it is EMR template data, profile information is also included.

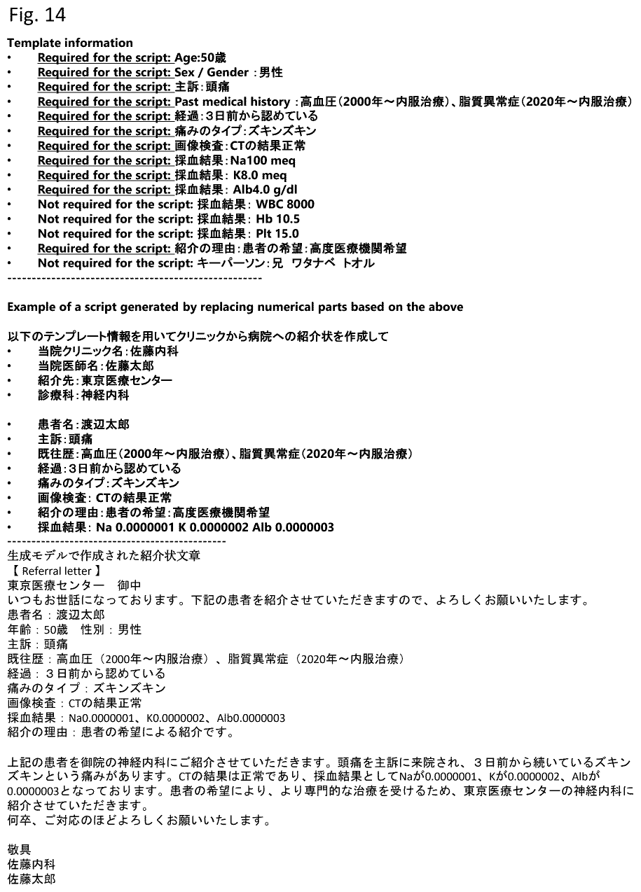

FIG. 14 is a diagram for explaining a generation procedure of referral letter text generated by the server 20 based on EMR template data.

An upper portion of FIG. 14 displays a list of EMR template data (input content) for a specific patient. The operator of the server 20 selects, from this list of input content, input content necessary and input content unnecessary for generation of the referral letter text (needed/not needed for the script).

When selection of the input content is completed, the server 20 generates a script to be input into a text generation task of a large language model. The generated script is displayed in a middle portion of FIG. 14. At this time, as already explained, some numerical values (in the illustrated example, numerical values of test results showing blood test results) are replaced with dummy values in order to confirm whether accurate text generation has been performed in the text generation by the text generation task.

A result of inputting the script into the text generation task of the large language model is shown in a lower portion of FIG. 14.

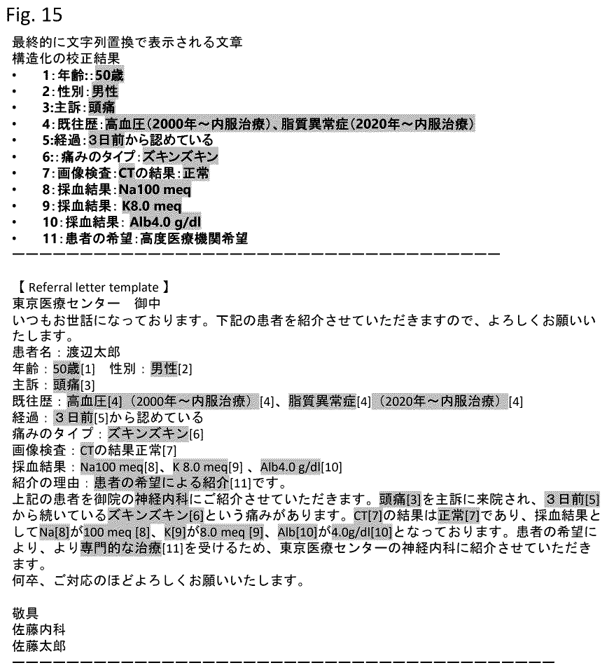

FIG. 15 is a diagram illustrating, in the generation procedure of the referral letter text shown in FIG. 14, an example in which the speech-recognition unit 196 performs string replacement.

### 5 Effects of One Embodiment

As described in detail above, according to the system 1 of the present embodiment, it is possible to append/modify a recorded content of a medical act, such as an entered electronic medical record, by a simple procedure. This point will be explained in detail below.

The medical industry is an industry in which mistakes are not allowed. In the medical industry, there is a very high need for structured data by a template. Structured data can reduce medical errors. By an EMR template, it is possible to standardize an operational workflow.

However, entering structured data into an electronic medical record is very laborious. For example, at an admission/discharge support center of a medical facility, there are input contents spanning about six pages, and instructing into which item each content is to be entered and then entering it took about 20 minutes per patient. According to the system 1 of the present embodiment, this work could be reduced to about 5 minutes.

Hitherto, the reasons why entry of structured data by using speech-recognition has not been used in the field are threefold. A first reason is that the accuracy of speech-recognition is not sufficient; a second reason is that there existed a method easier than speech-recognition for input; and a third reason is that it is difficult to correct mistakes.

In the system 1 according to the present embodiment, the first problem-namely the problem of speech-recognition accuracy—is eliminated by limiting the usage scene and, at the same time, displaying the input item name(s) of the template and candidate input content relating to the input item, thereby narrowing the patterns of speech to be input. In the system 1 according to the present disclosure, the Word Error Rate (WER) accompanying speech-recognition decreases from about 6% to about 2%.

The second problem is eliminated by first performing, before speech-recognition, input by a selectable-input-item (choice) method, which is an easier input than speech-recognition, and displaying the result, and then correcting or appending portions insufficient in that input by speech-recognition.

The third problem—that it is difficult to correct mistakes—is eliminated by, after input, displaying other candidates and enabling selection of the other candidates, and by making it easy to confirm on what speech the input was based.

Particularly, in the system 1 of the present embodiment, since selectable-form input content in most cases includes a designated medical term, the speech-recognition processing is performed using this designated medical term as a key and at least the selectable-form input content is specified; therefore, the accuracy of speech-recognition can be further improved.

### 6 Addition

Note that the embodiment described above has described the configuration in detail in order to make the present disclosure easy to understand, and is not necessarily limited to one that includes all of the described configurations. Further, with respect to a part of the configurations of the respective embodiments, addition, deletion, and substitution to other configurations is possible. As one example, in the embodiment described above, text data, and further, structured data, may be generated by a generative AI such as chat GPT. Also, speech data by utterance may be input, and text data that is a result of speech-recognition may be used as the text data. Furthermore, as characters consecutive to a designated medical term, symbols such as “:” or “ ” other than particles may be used. In addition, as one example of the input items of the EMR template, input items of a profile of an electronic medical record may be used. Also, specifying of template items may be divided into a plurality of steps; in a first iteration input items of structured data other than the template may be specified, and based on the data, subsequently the input items of the template may be specified.

Further, the above-mentioned respective configurations, functions, processing units, processing means, and the like may be implemented by hardware by, for example, designing an integrated circuit for a part or all thereof. Further, the present invention can also be realized by program code of software that realizes the functions of the embodiment. In this case, a storage medium on which the program code is recorded is provided to a computer, and a processor included in the computer reads out the program code stored in the storage medium. In this case, the program code read out from the storage medium itself realizes the functions of the embodiment described above, and the program code itself and the storage medium storing it constitute the present invention. As a storage medium for supplying such program code, for example, a flexible disk, a CD-ROM, a DVD-ROM, a hard disk, an SSD, an optical disk, a magneto-optical disk, a CD-R, a magnetic tape, a nonvolatile memory card, a ROM, or the like is used.

Further, program code that realizes the functions described in the present embodiment can be implemented in a wide range of programs or script languages such as assembler, C/C++, perl, shell, PHP, Java (registered trademark), and the like.

Furthermore, the program code of software that realizes the functions of the embodiment may be distributed via a network, stored in a storage means such as a hard disk or a memory of a computer, or a storage medium such as a CD-RW or CD-R, and a processor included in the computer may read out and execute the program code stored in the storage means or the storage medium.

Matters described in the respective embodiments above are additionally set forth below.

### Supplement 1

A program (181) for operating a computer including a processor (19) and a memory (15, 16), wherein structured data of an electronic medical record (EMR) template (182) is stored in the memory (15, 16), the structured data being data in which input items of the EMR template (182) and input content are associated, the input content including at least one of selectable input content for selecting a choice and free-text input content enabling free description, and the program (181) causes the processor (19) to execute: a first step (S504) of accepting, from a user, input of speech data (183), the speech data (183) including an input item of the EMR template (182) and input content corresponding to the input item of the EMR template (182); and a second step (S507) of identifying, based on at least one of the selectable input content and the free-text input content of the EMR template (182) included in the speech data (183), record content to be recorded in EMR template data (188).

### Supplement 2

A program (181) for operating a computer including a processor (19) and a memory (15, 16), wherein structured data of an EMR template (182) is stored in the memory (15, 16), the structured data being data in which input items of the EMR template (182) and input content are associated, the input content including selectable input content for selecting a choice, and the program (181) causes the processor (19) to execute: a first step (S504) of accepting, from a user, input of speech data (183), the speech data (183) including an input item of the EMR template (182) and input content corresponding to the input item; and a third step (S507) of identifying, based on at least the selectable input content among input content of the EMR template (182) included in the speech data (183), record content to be recorded in EMR template data (188).

### Supplement 3

The non-transitory computer-readable storage medium according to any one of the preceding Supplements, wherein the operations further comprise, after the second step, a fourth step of retrieving, with reference to the accepted text data, the structured data of the electronic medical record (EMR) template from the memory and identifying, based on the structured data, record content; and a fifth step of performing, using the identified record content, at least one of modification and addition to the input content of the EMR template.

### Supplement 4

The non-transitory computer-readable storage medium according to any one of the preceding Supplements, wherein the operations further comprise the sixth step described below.

### Supplement 4

The non-transitory computer-readable storage medium according to any one of the preceding Supplements, wherein the operations further comprise, after execution of at least the fifth step, a sixth step of evaluating, based on record content to be recorded in the electronic medical record (EMR) template data, whether an application for medical fee reimbursement is possible, and displaying a result of the evaluation.

### Supplement 5

The non-transitory computer-readable storage medium according to any one of the preceding Supplements, wherein the operations further comprise the seventh step described below.

In the fifth step (S507), changing a display mode of a portion at which at least one of modification and addition has been performed using the record content identified in the fourth step (S505), and explicitly indicating the portion at which at least one of the modification and the addition has been performed, the program (181) according to Supplement 3.

### Supplement 6

In the fourth step (S505), when there are a plurality of kanji conversion candidates in speech-recognition result data (184) based on speech data (183), displaying the kanji conversion candidates and accepting a selection input for one of the kanji conversion candidates so as to enable input of specific kanji in the speech-recognition result data (184), the program (181) according to Supplement 3.

### Supplement 7

In the fifth step (S507), when the record content identified in the fourth step (S505) is a personal name, performing at least one of modification and addition to input content of the electronic medical record (EMR) template (182) to unify at least a part of the personal name to a katakana notation or a hiragana notation of the personal name, the program (181) according to Supplement 3.

### Supplement 8

Input content and speech data (183) include an item number (label), and in the fourth step (S505), identifying the record content based on the item number (label), the program (181) according to Supplement 3.

### Supplement 9

The electronic medical record (EMR) template (182) includes table information, the speech data (183) in the first step (S504) including: particles or terms that identify a column of a table in the table information; and a term that signifies movement to information input of a next row in the table information or a term that identifies a row, and in the second step (S507), identifying record content for a specific row and column, the program (181) according to Supplement 1.

### Supplement 10

In the input content and the speech data (183), respective designated medical terms are included, and in the fourth step (S505), identifying the record content using a designated medical term included in the speech-recognition result data (184) and a designated medical term included in the input content, the program (181) according to Supplement 3.

### Supplement 11

In the fourth step (S505), presenting a guide indicating at least one of a designated medical term, an item number (label), or an item name together with selectable input content choices or input examples for an input item, the program (181) according to Supplement 10.

### Supplement 12

The program (181) further causes the processor (19) to execute a seventh step of displaying, on a same screen, at least one of a designated medical term, an item number (label), or an item name included in the input item, the input content, and the speech-recognition result data (184), and in the seventh step, also displaying on the same screen an input item of the electronic medical record (EMR) template (182) relating to the record content identified in the fourth step (S505), the program (181) according to Supplement 11.

### Supplement 13

In the seventh step, starting speech playback of the speech data (183) by accepting a selection instruction for a displayed input item, the program (181) according to Supplement 12.

### Supplement 14

In the first step (S504), storing the speech data (183) in a memory (15, 16), and in the fourth step (S505), starting speech playback of the speech data (183) by accepting a selection instruction for an input item displayed in the seventh step, and along with playback of the speech data (183) continuously changing display positions of the input item and the input content, the program (181) according to Supplement 12.

### Supplement 15

The program (181) further causes the processor (19) to execute an eighth step (S601) of accepting electronic medical record (EMR) template data (188) or personal healthcare record data in which input content has already been entered, and in the fourth step (S505), displaying with a changed display mode: the input content of the EMR template data (188) accepted in the eighth step (S601), input items and input content of the electronic medical record (EMR) template (182), and a speech-recognition result by the speech-recognition result data (184), the program (181) according to Supplement 12.

### Supplement 16

In the fourth step (S505), identifying a combination of a designated medical term that is a noun and a particle connecting to the designated medical term from the speech-recognition result data (184), and identifying the record content based on the combinations of the designated medical terms and the particles, the program (181) according to Supplement 3.

### Supplement 17

A speech-recognition engine (186, 187) for performing speech-recognition is stored in the memory (15, 16), the speech-recognition engine (186, 187) including a learned model (187) learned by training data (186) including designated medical terms, the program (181) according to Supplement 3.

### Supplement 18

The speech-recognition engine (186, 187) includes a learned model (187) learned by training data (186) including input items and input content, the program (181) according to Supplement 17.

### Supplement 19

The program (181) further causes the processor (19) to execute a ninth step (S601) of accepting electronic medical record (EMR) template data (188) in which input content has already been entered and performing anonymization processing on a part of the accepted input content of the EMR template data (188), and based on the input content of the EMR template data (188) accepted in the ninth step (S601), generating teacher speech reading data of the speech-recognition engine (186, 187), creating speech correct data based on the teacher speech reading data, and performing machine learning of the learned model (187) based on the speech correct data, the program (181) according to Supplement 18.

### Supplement 20

In the electronic medical record (EMR) template (182), identifiers for identifying input items of each electronic medical record (EMR) template (182) are associated, the program (181) according to Supplement 1.

### Supplement 21

The electronic medical record (EMR) template (182) is shareable among a plurality of medical facilities, and an identical identifier is associated with EMR templates (182) that are shareable among the plurality of medical facilities, the program (181) according to Supplement 1.

### Supplement 22

The program (181) causes the processor (19) to execute a tenth step (S700) of accepting an import of the electronic medical record (EMR) template (182), and in the tenth step (S700), not changing an identifier upon import of the electronic medical record (EMR) template (182), the program (181) according to Supplement 21.

### Supplement 23

Identifiers for identifying respective input items are associated with the input items of the electronic medical record (EMR) template (182), and the program (181) causes the processor (19) to execute an eleventh step (S701) of exporting the accepted electronic medical record (EMR) template (182) after accepting an import of the electronic medical record (EMR) template (182), and a twelfth step (S702) of generating a correspondence table from position consistency of the input items of the imported and exported electronic medical record (EMR) template (182) in the eleventh step (S701), and updating correspondence between the speech-recognition result data (184) and the input items of the electronic medical record (EMR) template (182) by replacing identifiers based on the generated correspondence table, the program (181) according to Supplement 3.

### Supplement 24

The program (181) causes the processor (19) to execute a thirteenth step of accepting a selection input for an input item of the electronic medical record (EMR) template (182), and a fourteenth step of creating at least one of a referral letter, a medical summary, or a report for a pharmaceutical company by using a sentence template or by creating a prompt for a language generation model and using the language generation model based on input content corresponding to the input item for which the selection input has been accepted in the thirteenth step, the program (181) according to Supplement 3.

### Supplement 25

The program (181) causes the processor (19) to execute a fifteenth step of accepting a selection input for an input item of the electronic medical record (EMR) template (182), and a sixteenth step of creating, based on input content corresponding to the input item for which the selection input was made in the fifteenth step, a prompt for a language generation model, and using the language generation model to create at least one of a referral letter template, a medical summary template, or a report for a pharmaceutical company in which correspondence between the input content of the electronic medical record (EMR) template (182) and sentences is linked, the program (181) according to Supplement 3.

### Supplement 26

An information processing device comprising: a processor (19) and a memory (15, 16), the memory (15, 16) storing structured data of an electronic medical record (EMR) template (182), the structured data being data in which input items of the electronic medical record (EMR) template (182) and input content are associated, the input content including selectable input content for selecting among choices and free-text input content allowing free description; the processor (19) being configured to execute a first step (S504) of accepting, from a user, speech data (183) that includes an input item of the electronic medical record (EMR) template (182) and input content corresponding to the input item, and a second step (S507) of identifying, based on at least one of selectable input content and free-text input content of the electronic medical record (EMR) template (182) included in the speech data (183), record content to be recorded in electronic medical record (EMR) template data (188).

### Supplement 27

An information processing device comprising: a processor (19) and a memory (15, 16), the memory (15, 16) storing structured data of an electronic medical record (EMR) template (182), the structured data being data in which input items of the electronic medical record (EMR) template (182) and input content are associated, the input content including selectable input content for selecting among choices; the processor (19) being configured to execute a first step (S504) of accepting, from a user, speech data (183) that includes an input item of the electronic medical record (EMR) template (182) and input content corresponding to the input item, and a third step (S507) of identifying, based on at least the selectable input content of the electronic medical record (EMR) template (182) included in the speech data (183), record content to be recorded in electronic medical record (EMR) template data (188).

### Supplement 28

A method executed by a computer (10) comprising a processor (19) and a memory (15, 16), the method comprising: storing, in the memory (15, 16), structured data of an electronic medical record (EMR) template (182), the structured data being data in which input items of the electronic medical record (EMR) template (182) and input content are associated, the input content including selectable input content for selecting among choices and free-text input content allowing free description; executing, by the processor (19), a first step (S504) of accepting, from a user, speech data (183) including an input item of the electronic medical record (EMR) template (182) and input content corresponding to the input item; and executing, by the processor (19), a second step (S507) of identifying, based on at least one of selectable input content and free-text input content of the electronic medical record (EMR) template (182) included in the speech data (183), record content to be recorded in electronic medical record (EMR) template data (188).

### Supplement 29

A method executed by a computer (10) comprising a processor (19) and a memory (15, 16), the method comprising: storing, in the memory (15, 16), structured data of an electronic medical record (EMR) template (182), the structured data being data in which input items of the electronic medical record (EMR) template (182) and input content are associated, the input content including selectable input content for selecting among choices; executing, by the processor (19), a first step (S504) of accepting, from a user, speech data (183) including an input item of the electronic medical record (EMR) template (182) and input content corresponding to the input item; and executing, by the processor (19), a third step (S507) of identifying, based on at least the selectable input content of the electronic medical record (EMR) template (182) included in the speech data (183), record content to be recorded in electronic medical record (EMR) template data (188).

### Supplement 30

A system (1) comprising: a memory (15, 16) storing structured data of an electronic medical record (EMR) template (182), the structured data being data in which input items of the electronic medical record (EMR) template (182) and input content are associated, the input content including selectable input content for selecting among choices and free-text input content allowing free description; means (196) for accepting, from a user, speech data (183) including an input item of the electronic medical record (EMR) template (182) and input content corresponding to the input item; and means (197) for identifying, based on at least one of selectable input content and free-text input content of the electronic medical record (EMR) template (182) included in the speech data (183), record content to be recorded in electronic medical record (EMR) template data (188); and a system (1) comprising: a memory (15, 16) storing structured data of an electronic medical record (EMR) template (182), the structured data being data in which input items of the electronic medical record (EMR) template (182) and input content are associated, the input content including selectable input content for selecting among choices; means (196) for accepting, from a user, speech data (183) including an input item of the electronic medical record (EMR) template (182) and input content corresponding to the input item; and means (197) for identifying, based on at least the selectable input content of the electronic medical record (EMR) template (182) included in the speech data (183), record content to be recorded in electronic medical record (EMR) template data (188).

What is claimed is:

1. A terminal device comprising:
a memory; and
one or more processors operatively coupled to the memory and configured to:
maintain, in the memory, structured data of an electronic medical record (EMR) template, the structured data associating input items of the EMR template with input content, the input content including at least one of selectable input content and free text input content;
accept, from a user, text data including an input item of the EMR template and input content corresponding to the input item; and
identify, based on at least one of the selectable input content and the free text input content included in the text data, record content to populate the EMR template data.

2. The terminal device according to claim 1, wherein the text data is generated by a speech recognition engine configured to convert a voice input into text.

3. The terminal device according to claim 1, wherein the processors are further configured to present, on a display, an input guide for specified medical terms, to present conversion candidates for the input content, and to accept a user selection.

4. The terminal device according to claim 1, wherein the processors are further configured to:
create, from structured data of the EMR template, a prompt for a document generation task of a large language model, change, to values that are difficult to collide, values presented in the prompt, and perform the document generation task using the prompt;
represent each said value that is difficult to collide in a collision resistant format notation, maintain correspondence by associating the value that is difficult to collide appearing in the generated document with a respective original actual value and simultaneously substituting the numbers, thereby populating the generated medical document with respective values of the identified record content corresponding to the input items; and
output the generated medical document.

5. A server comprising:
a communication interface;
a memory storing EMR template data and an EMR database; and
one or more processors configured to:
maintain structured data of an EMR template associating input items with input content;
receive, from a terminal device, text data including an input item and input content corresponding thereto;
identify record content based on at least one of selectable input content and free text input content included in the text data; and
record the identified record content in the EMR database.

6. A system comprising the terminal device according to claim 1 and the server according to claim 5, the terminal device and the server being communicatively coupled via a network.
